(19) United States
(12) Patent Application Publication
(10) Pub. No.: US 2010/0020363 A1
(43) Pub. Date: Jan. 28, 2010

(54) IMAGE FORMING APPARATUS

(75) Inventors: Mayuko Yoshida, Osaka (JP); Kumiko Ogino, Osaka (JP)

Correspondence Address: EDWARDS ANGELL PALMER & DODGE LLP, P.O. BOX 55874, BOSTON, MA, 02205, US

(73) Assignee: SHARP KABUSHIKI KAISHA, Osaka (JP)

(21) Appl. No.: 12/496,167

(22) Filed: Jul. 1, 2009

(30) Foreign Application Priority Data
Jul. 25, 2008 (JP) 2008-192500

(51) Int. Cl. H04N 1/32

(52) U.S. Cl. 358/468

(57) ABSTRACT

By enabling the confirmation of a finish state by a preview reliably, it makes it possible to prevent unnecessary image formation processing due to setting errors by a user. Finish state information showing a finish state of paper is simultaneously displayed in addition to a preview image showing an entire page of image data on a preview screen before performing image formation. The finish state information is displayed, for example, as “2-sided: Front 1” showing to be the first page in 2-sided printing. In addition thereto, an icon showing to be a front side in 2-sided printing is displayed at the same time. This display allows the user to recognize that a setting of 2-sided printing is performed and image data of the current preview image is the front side of the first page in the 2-sided printing.

### CROSS-NOTING PARAGRAPH

This non-provisional application claims priority under U.S.C. §119(a) on Patent Application No. 2008-192500 filed in JAPAN on Jul. 25, 2008, the entire contents of which are hereby incorporated herein by reference.

### FIELD OF THE INVENTION

The present invention relates to an image forming apparatus, more specifically, to an image forming apparatus having a function of previewing image data read from an original image before image formation.

### BACKGROUND OF THE INVENTION

Conventionally, some image forming apparatuses such as copiers have a function of displaying a preview of image data for performing image formation before the image formation.

For example, there is an image forming apparatus capable of, in performing image formation (printing) of image data of an original read by a scanner or image data sent from an external device, performing image formation after a preview of the image data targeted for image formation is displayed and a user confirms the display.

There is also an image forming apparatus that enables, in performing image formation of image data by the image forming apparatus, to perform various output processing in accordance with a setting by a user. For example, there are 2-sided printing processing for forming an image on both sides of paper, inter-leaf processing for inserting different kinds of paper to a predetermined position of paper for performing image formation, and OHP inter-leaf processing for inserting protection paper between sheets of OHP paper, as well as processing for inserting other paper as a front cover to a top page position of paper for performing image formation, processing for inserting other paper as a back cover to a last page position, and the like. In addition, there is processing related to staple and punch applied to paper for performing image formation or a setting of header and footer.

In order to confirm such a finish state, there has been proposed a method for performing a preview display showing a finish state in advance before performing image formation. For example, there is a method in which, when a user sets 2-sided printing processing as a finish state, the set finish state is displayed on a preview screen.

For example, Japanese Laid-Open Patent Publication No. 2003-80791 discloses a printer control technology for allocating header footer information to a printing medium. Here, a printer control apparatus includes an allocation information input processing portion for inputting and designating information related to header and footer from a displayed screen, a header footer printing area setting portion for setting a header footer printing area to paper based on allocation information from the allocation information input processing portion, and a header footer information generating portion for generating header footer information to be allocated to the header footer printing area based on allocation information. When print data formed by an application not mounted with a header footer information adding function is printed, if allocation information of header footer information is designated, a header footer allocation control processing portion adds the header footer information to print data and outputs to a printer.

Further, Japanese Laid-Open Patent Publication No. 2008-70835 discloses an image forming apparatus that generates an output image in which an image of post processing applied to a medium and an image are displayed together for previewing. Here, the image forming apparatus that performs post processing for a medium on which an image is to be formed after the image is formed includes a control portion for controlling a post processing portion that performs post processing and an output image generating portion for generating an output image of a medium on which an image is formed and the post processing is performed.

Further, Japanese Laid-Open Patent Publication No. 2004-36809 discloses an image forming apparatus that prevents setting errors of a binding position with a simple operation. The image forming apparatus displays an original read image on a preview screen. Here, a staple position is set and the staple position is confirmed on the preview screen. The display on the preview screen is able to be performed at high speed when an image area is simply shown and the staple position and a screen area are displayed at the same time. When the staple position is in the image area, a display color is changed to emit a warning, or a non-image area is shown on the preview screen to display the staple position and the non-image area at the same time. When the staple position is out of the non-image area, a display color is changed to emit a warning. Alternatively, when the staple position is set in the image area, an image data area is reduced. By turning pages of the preview screen with the staple position as a base point, errors of the staple position are found before printing.

Further, Japanese Laid-Open Patent Publication No. 2008-42417 discloses an image processing apparatus capable of notifying why a selected setting item can not be set. Here, when a setting item to be set is selected on a preview image and it is determined that the selected setting item is mutually exclusive with a setting item already set on the preview image, a position at which processing of the mutually exclusive setting item is applied is displayed on a display unit in a form different from a position at which processing of other setting items is applied. When the position at which processing of the setting item displayed on the display unit in a form different from the position at which processing of other setting items is applied is selected, a dialogue describing why the selected setting item can not be set is displayed.

In post-processing in which physical processing such as staple, for example, is applied to paper for performing image formation as print conditions, the same processing is applied to all pages, and therefore, even when a finish state is equally displayed on a reduced image for each page, it is possible to easily and visually recognize, however, when 2-sided printing processing for forming an image on both sides of paper, inter-leaf processing for inserting different kinds of paper to a predetermined position of paper for performing image formation, OHP inter-leaf processing for inserting protection paper between sheets of OHP paper, processing for inserting different kinds of paper as a front cover to a top page position of paper for performing image formation, or processing for inserting different kinds of paper as a back cover to a last page position is set as print conditions, it has raised a problem that it is difficult for a user to confirm visually because it is necessary to recognize whether the print conditions are set appropriately, or based on which, in what state the printed matter is output and how the entire printed matter is laid out.

Accordingly, a technology capable of confirming a finish state in a preview image more reliably has been required.

### SUMMARY OF THE INVENTION

An object of the present invention is to provide an image forming apparatus that enables to prevent unnecessary image formation processing due to setting errors by a user by making it possible to confirm a finish state on a preview screen reliably.

Another object of the present invention is to provide an image forming apparatus that includes a display portion; an operation input portion for performing operation input in accordance with a display of the display portion; an image forming portion for performing image formation of image data; and a display control portion for displaying a preview image of the image data on the display portion before performing the image formation, wherein in a state where the preview image of the image data is displayed, operation input for displaying a finish state of image formation is possible by the operation input portion and when operation input for displaying the finish state is performed for the operation input portion, the display control portion causes the display portion to display information showing the finish state separately from the preview image of the image data according to finish conditions set to the image forming apparatus.

Another object of the present invention is to provide the image forming apparatus, wherein while information showing the finish state is displayed on the display portion, when operation input for displaying the finish state is performed by the operation input portion again, the display control portion deletes a display showing the finish state that is displayed on the display portion.

Another object of the present invention is to provide the image forming apparatus, wherein while information showing the finish state is displayed on the display portion, when operation input for displaying the finish state is performed by the operation input portion again, the display control portion returns to a display in which the preview image of the image data is displayed and information showing the finish state is not displayed.

Another object of the present invention is to provide the image forming apparatus, wherein when causing the display portion to display information showing the finish state, the display control portion displays a reduced image showing an entire page of a page of image data for performing image formation as the preview image, and displays page information of a page corresponding to the reduced image and the reduced image at the same time as information showing the finish state.

Another object of the present invention is to provide the image forming apparatus, wherein the page information includes information related to 2-sided printing processing for performing image formation on both sides of paper.

Another object of the present invention is to provide the image forming apparatus, wherein the page information includes information related to the inter-leaf processing for inserting paper as an inter-leaf in a predetermined position for performing image formation.

Another object of the present invention is to provide the image forming apparatus, wherein the page information includes information related to OHP inter-leaf processing for inserting sheets of paper as inter-leaves between sheets of OHP paper.

Another object of the present invention is to provide the image forming apparatus, wherein the page information includes information related to front cover insertion processing for inserting a sheet of paper as a front cover in a top page position for performing image formation.

Another object of the present invention is to provide the image forming apparatus, wherein the page information includes information related to back cover insertion processing for inserting a sheet of paper as a back cover in the last page position for performing image formation.

Another object of the present invention is to provide the image forming apparatus, wherein the page information includes information displayed by an icon.

Another object of the present invention is to provide the image forming apparatus, wherein a sending portion for sending image data to an external device is included, and before image data is sent by the sending portion, the display control portion causes the display portion to display a preview image of the image data and information showing a finish state separately from the preview image in accordance with finish conditions set in the image forming apparatus.

### BRIEF DESCRIPTION OF THE DRAWINGS

FIG. 1 is a schematic diagram for showing an exemplary configuration of an image processing system constructed by using a digital multi-functional peripheral as an example of an image forming apparatus according to an embodiment of the present invention;

FIG. 2 is a schematic block diagram for showing an exemplary configuration of the digital multi-functional peripheral of FIG. 1;

FIG. 3 is an external view for showing an example of a touch panel and a key operation portion in the digital multi-functional peripheral of FIG. 2;

FIG. 4 is a diagram for showing an example of a standard screen of the digital multi-functional peripheral;

FIG. 5 is a diagram for showing an example of a display screen when a preview confirm key is operated on the standard screen of FIG. 4;

FIG. 6 is a flowchart for explaining an example of preview display processing in the digital multi-functional peripheral;

FIG. 7 is a diagram for showing an example of a setting screen of 2-sided printing in the digital multi-functional peripheral;

FIGS. 8A and 8B are diagrams for showing an exemplary display of information related to 2-sided printing processing as an example of a finish state;

FIGS. 9A and 9B are diagrams for showing another exemplary display of information related to 2-sided printing as an example of a finish state;

FIGS. 10A and 10B are diagrams for showing still another exemplary display of information related to 2-sided printing as an example of a finish state;

FIGS. 11A and 11B are diagrams for showing still another exemplary display of information related to 2-sided printing as an example of a finish state;

FIG. 12 is a diagram for explaining a cover setting in the digital multi-functional peripheral;

FIGS. 13A to 13C are diagrams for showing a display screen for a cover setting in the digital multi-functional peripheral;

FIGS. 14A to 14C are diagrams for showing an exemplary display of information related to front cover/back cover insertion processing as another example of a finish state;

FIG. 15 is a diagram for showing another example of an icon showing a finish state;

FIGS. 16A and 16B are diagrams for showing another exemplary display of information related to front cover/back cover insertion processing as another example of a finish state;

FIG. 17 is a diagram for explaining an inter-leaf setting in the digital multi-functional peripheral;

FIGS. 18A to 18C are diagrams for showing a display screen for an inter-leaf setting in the digital multi-functional peripheral;

FIGS. 19A to 19C are diagrams for showing an exemplary display of information related to insertion of an inter-leaf as another example of a finish state;

FIGS. 20A and 20B are diagrams for showing another exemplary display of information related to an inter-leaf as another example of a finish state;

FIGS. 21A and 21B are diagrams for showing still another exemplary display of information related to an inter-leaf as another example of a finish state;

FIG. 22 is a diagram for explaining an OHP inter-leaf setting in the digital multi-functional peripheral;

FIGS. 23A and 23B are diagrams for showing a display screen for an OHP inter-leaf setting in the digital multi-functional peripheral;

FIGS. 24A and 24B are diagrams for showing an exemplary display of information related to OHP inter-leaves as still another example of a finish state;

FIGS. 25A and 25B are diagrams for showing another exemplary display of information related to OHP inter-leaves as still another example of a finish state;

FIGS. 26A and 26B are diagrams for showing another exemplary display of information related to OHP inter-leaves as still another example of a finish state;

FIG. 27 is a diagram for showing an exemplary display of information related to a staple function as still another example of a finish state;

FIG. 28 is a diagram for showing an exemplary display of information related to a punch function as still another example of a finish state;

FIG. 29 is a diagram for showing an exemplary display for displaying a plurality of finish states at the same time; and

FIG. 30 is a diagram for showing an exemplary display of finish state information in a preview display in sending image data.

### PREFERRED EMBODIMENTS OF THE INVENTION

Now, a preferred embodiment of the present invention will hereinafter be described with reference to the drawings. An embodiment in which an image forming apparatus according to the present invention is applied to a digital multi-functional peripheral having a print function, a copy function, and a facsimile sending and receiving function, etc., will hereinafter be described specifically with reference to the drawings showing the embodiment.

### <Apparatus Configuration>

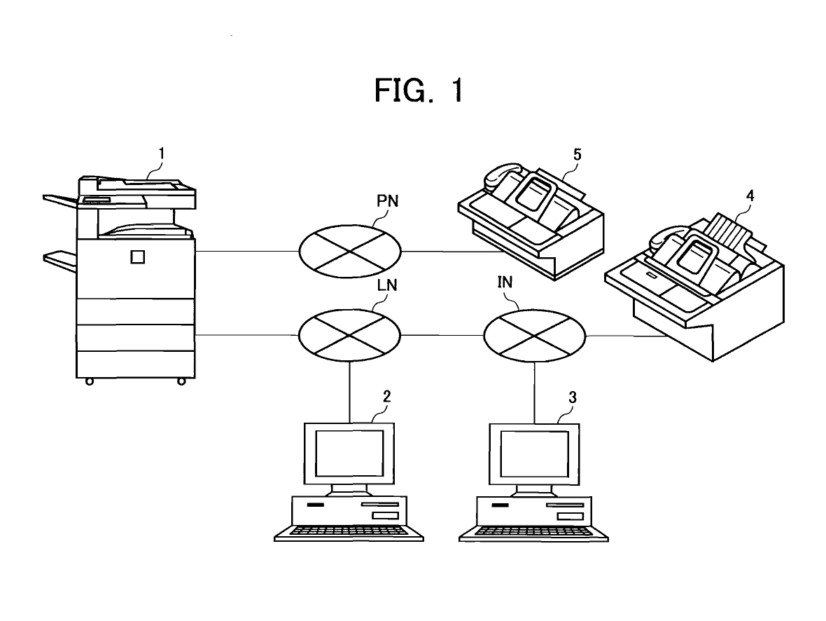

FIG. 1 is a schematic diagram for showing an exemplary configuration of an image processing system constructed by using a digital multi-functional peripheral as an example of an image forming apparatus according to an embodiment of the present invention. In FIG. 1, 1 denotes a digital multi-functional peripheral, 2 and 3 denote external computers, 4 denotes an internet facsimile apparatus (internet FAX apparatus), and 5 denotes a facsimile apparatus.

The digital multi-functional peripheral 1 is one of embodiments of the image forming apparatus of the present invention, and has a print function and a copy function, as well as a function of sending and receiving image data by facsimile (facsimile function) and/or a function of sending and receiving image data by internet FAX (internet FAX function). This digital multi-functional peripheral 1 is connected to various external devices through a communication network. For example, the external computer 2 such as a personal computer (PC) is connected to a communication network LN that is laid as a local communication network, and the external computer 3 and the internet FAX apparatus 4 are connected to an internet network IN that is connected through a gateway (not-shown) or the like. Further, the external facsimile apparatus 5 is connected to the digital multi-functional peripheral 1 through a public switched telephone network PN.

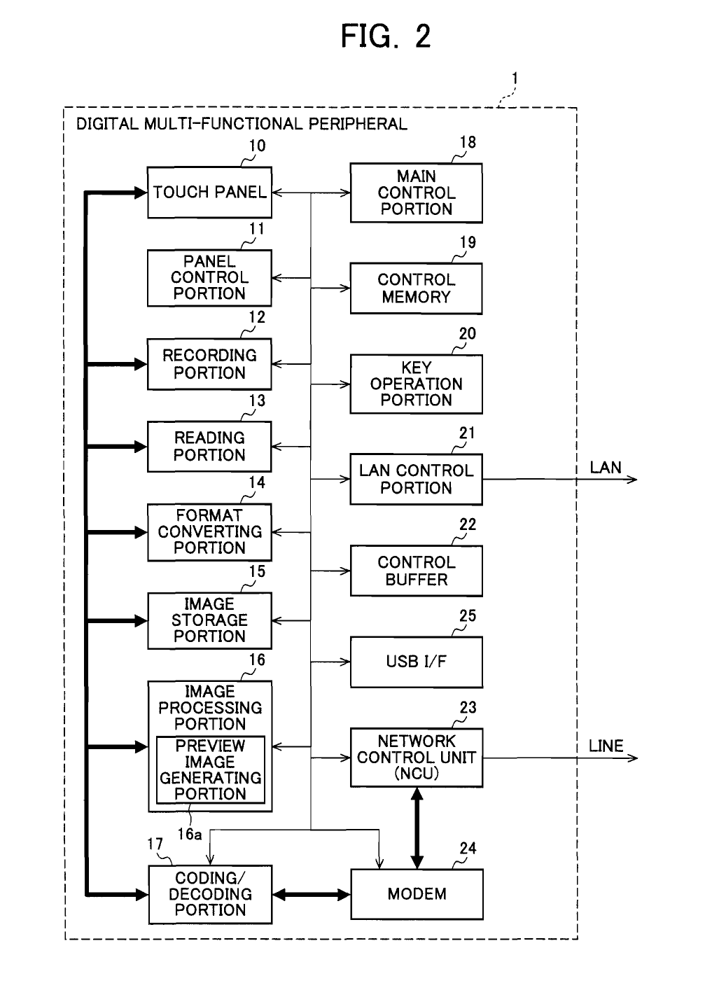

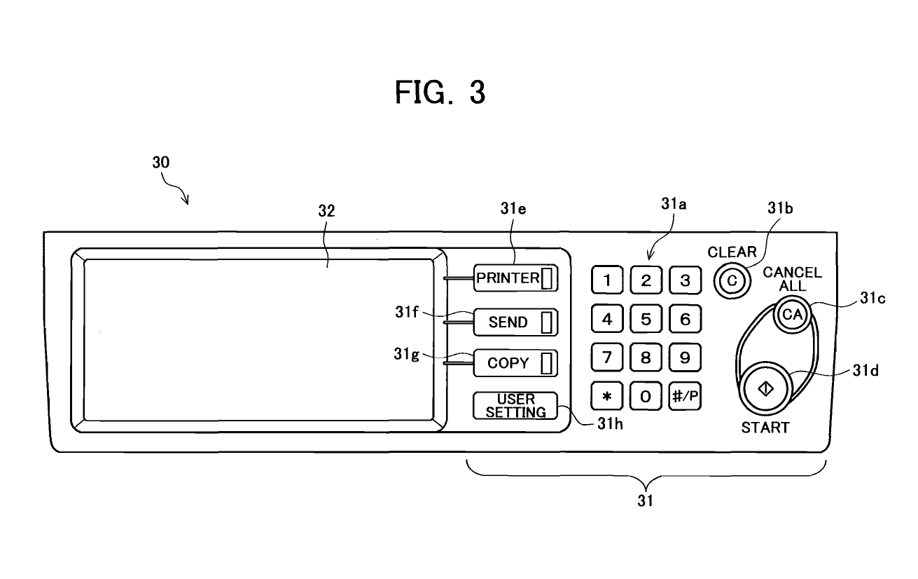

Description will be given for a configuration and an operation of the digital multi-functional peripheral 1. FIG. 2 is a schematic block diagram for showing an exemplary configuration of the digital multi-functional peripheral of FIG. 1, and FIG. 3 is an external view for showing an example of a touch panel and a key operation portion of the digital multi-functional peripheral of FIG. 2.

The digital multi-functional peripheral 1 illustrated in FIG. 2 is provided with a touch panel 10, a panel control portion 11, a recording portion 12, a reading portion 13, a format converting portion 14, an image storage portion 15, an image processing portion 16, a coding/decoding portion 17, a main control portion 18, a control memory 19, a key operation portion 20, a LAN (Local Area Network) control portion 21, a control buffer 22, a network control unit (NCU) 23, a modem 24, and a USB (Universal Serial Bus) interface (I/F) 25.

The main control portion 18 is comprised of a CPU (Central Processing Unit), a DSP (Digital Signal Processor), or the like. The control memory 19 is comprised of a nonvolatile memory or the like such as a ROM (Read Only Memory) or an EEPROM (Electrically Erasable and Programmable ROM). A program (firmware) and various setting data are stored in the control memory 19 so as to be readable from the main control portion 18. Among them, at least various setting data is stored in a rewritable memory. The program and the various setting data may be stored in the image storage portion 15. The control buffer 22 is comprised of a volatile memory such as a RAM (Random Access Memory).

The above-described program is used for the main control portion 18 to carry out commands concerning generation and display of a preview image, which will be described below, according to the present invention, as well as commands concerning generation/sending/reception, etc., of a facsimile image and an electronic mail, etc., a command concerning reading of an original, a command concerning printing, a command concerning reading and printing (that is, copying) of an original, and the like, with respect to other parts. This program is developed by the main control portion 18 on the control buffer 22 and is executed by referring to various setting data properly, which will be described below, using the control buffer 22 as a data area for temporal storing (working).

The reading portion 13 reads an original as a bitmap image of RGB (R: Red, G: Green, and B: Blue) with a predetermined resolution by a scanner using a CCD (Charge Coupled Device) and outputs the read RGB image data (dot image data) to the image processing portion 16. The image processing portion 16 is comprised of an ASIC (Application Specific Integrated Circuit) or the like, and applies various image processing to target image data. The ASIC may be incorporated with other parts such as the coding/decoding portion 17.

The image storage portion 15 is comprised of hard disc or the like, and stores image data that has been read by the reading portion 13 and has passed through the image processing portion 16, image data that has been received from outside through the LAN control portion 21, the NCU 23, etc., and the like. When image data is stored in the image storage portion 15, data that has been coded by the coding/decoding portion may be also stored. Moreover, the image storage portion 15 may temporarily save intermediate data generated during image processing at the image processing portion 16.

The coding/decoding portion 17 compresses image data by coding and decodes (expands) the coded image data to original image data. For example, the coding/decoding portion 17 performs coding of image data read from an original, decoding of the coded data, decoding of coded image data received from outside, and the like. In the coding/decoding portion 17, coding systems corresponding to purposes are usable, including JPEG (Joint Photographic Experts Group) that is generally used in filing, and MH (Modified Huffman), MR (Modified READ) and MMR (Modified Modified READ) that are generally used in facsimile communication. As the coding system, MH is employable in IP facsimile communication, and MH, MR, and MMR as well as JPEG and JBIG (Joint Bi-level Image Experts Group) are employable in internet facsimile communication.

The format converting portion 14 converts read image data or image data received from outside into a predetermined file format such as a PDF (Portable Document Format), a GIF (Graphics Interchange Format), or a TIFF (Tag Image File Format).

The recording portion 12 is provided with a printer apparatus that employs a printing system such as an electrophotographic system or an inkjet system, and functions as an image forming portion that records (that is, prints) image data and the like stored in the image storage portion 15 on recording paper. The USB I/F 25 is an I/F for connecting to a USB device such as a USB memory, and outputs image data and the like after original reading that is stored in the image storage portion 15 or reads a file from the USB device.

The modem 24 is comprised of a facsimile modem capable of facsimile communication, and is connected to a telephone line and is directly connected to the NCU 23. The NCU 23 is connected to the telephone line to control the line. That is, the NCU 23 is hardware that performs an operation of closing and opening the line with an analogue public switched telephone network (PSTN), and connects the modem 24 to the public switched telephone network as necessary. Such a configuration enables to send image data stored in the image storage portion 15 to outside by facsimile, to receive facsimile image data from the telephone line to store in the image storage portion 15, or to print by the recording portion 12 directly.

The LAN control portion 21 is connected to a LAN and performs communication of electronic mail data and communication of internet FAX via an internet. The internet FAX uses a LAN interface or the like to send and receive an electronic mail through a computer network such as a LAN.

The touch panel 10 or the key operation portion 20 is an operation input portion that receives an operation for selecting desired processing out of processing of reading an original, processing of sending image data and printing etc., an operation for starting the processing, an operation for performing a setting that is necessary when each processing is executed (a selecting operation or an inputting operation), and the like.

The key operation portion 20 is provided with a key group necessary for operations. The touch panel 10 has a display portion and an operation receiving portion such as a touch sensor. The touch panel 10 is given a display control and an operation reception control from the panel control portion 11. That is, the panel control portion 11 performs the display control for the display portion and the operation reception control for the operation receiving portion in the touch panel 10.

On the display portion of the touch panel 10, a current operating state, setting information, and the like are displayed. The display is realized when the panel control portion 11 performs control to display a GUI (Graphical User Interface) image. The GUI enables to change the display and an operation received position depending on a user operation. Each GUI and an image thereof may be stored so as to be readable in an internal memory of the panel control portion 11 or the control memory 19. In addition, as the display portion, display devices in various display systems including liquid crystal displays and organic EL (Electroluminescence) displays are employable.

The user operation received on the touch panel 10 is interpreted by the panel control portion 11 and is transmitted as an operation signal to the main control portion 18. The user operation received by the key operation portion 20 is interpreted by the key operation portion 20 itself and transmitted as an operation signal to the main control portion 18. The main control portion 18 issues a command corresponding to the operation signal obtained in this manner to other parts to cause the other parts to execute processing in accordance with the user operation. Note that, although description has been given with reference to the touch panel 10 in which the display device and the operation portion are integrated, only the display apparatus may be simply provided instead of the touch panel 10 and, in that case, the user operation is received only by the key operation portion 20.

The touch panel 10 and the key operation portion 20 are configured as an operation panel 30 as illustrated in FIG. 3. In this example, the operation panel 30 is comprised of a key operation portion 31 (corresponding to the key operation portion 20) provided with various hardware keys and a touch panel 32 (corresponding to the touch panel 10) comprising a liquid crystal display and a touch sensor. The present invention will hereinafter be described in detail with the touch panel 32 and the key operation portion 31 applied to the configuration of FIG. 3 instead of the touch panel 10 and the key operation portion 20.

The key operation portion 31 is provided with, as hardware keys, a numeric keypad 31a for inputting numeric values, a clear key 31b for clearing input set values, a cancel all key 31c for canceling all of various input settings, and a start key 31d for receiving instructions of start of copying, start of sending, etc., as well as function switch keys 31e, 31f, and 31g for switching a print function, a sending function and a copy function, and a system setting key 31h for receiving a setting by a user.

An exemplary operation in the digital multi-functional peripheral 1 having the above-described exemplary configuration will be described.

### <Original Reading Operation>

An original reading operation is performed when image data of a read original is stored (filed) in the image storage portion 15, when image data of a read original is sent to outside, when image data of a read original is printed (that is, copied), and the like.

When a user operation to perform processing requiring original reading is received by the operation panel 30, the main control portion 18 gives an instruction to the reading portion 13, the image storage portion 15, the image processing portion 16, the coding/decoding portion 17, and the like to execute processing as will be described below.

The reading portion 13 optically reads an image of an original placed on a document platen or an automatic document feeder and provides the image processing portion 16 with RGB image data (bitmap data of RGB) as a result of reading. The image processing portion 16 executes various image processing (hereinafter, referred to as original image processing) such as A/D conversion, shading correction, and γ correction for the RGB image data. Here, the shading processing is the processing to remove various distortions generated in an illumination system, an image focusing system, and an image sensing system of the reading portion 13.

As the original image processing, original determination processing and segmentation processing may be executed subsequently to the A/D conversion, the shading correction, and the γ correction. The original determination processing includes processing of determining a type of the original and processing of determining whether the original is a color original or a monochromatic original based on input image data (image data after the application of the γ correction, in this case). Examples of the type of the original include a text original, a printed photograph original, and text and printed photograph original in combination thereof. The image processing portion 16 outputs a determination signal (hereinafter, referred to as original determination data) as a result of the original type determination processing and the monochromatic/color original determination processing.

The segmentation processing is processing of determining to what kind of area each pixel of the input image data (image data after the application of the γ correction, in this case) belongs, and an example thereof includes processing of determining to which area including a black text area, a color text area and a halftone area each pixel belongs. The image processing portion 16 outputs segmentation data as a result of the determination. Note that, the segmentation processing may be executed based on the result of the above-described original determination processing and monochromatic/color original determination processing.

The original determination data and the segmentation data are stored in the image storage portion 15 in association with corresponding image data (image data after the application of the original image processing). At this time, the original determination data and the segmentation data are coded by the coding/decoding portion 17 and each coded data is thereafter stored in the image storage portion 15 in association with the corresponding image data. Note that, although the coding in storing in the image storage portion 15 is not essential, description will be given assuming that the image data is stored in a state of being coded. This is also the same in operations other than the original reading operation.

### <Printing Operation>

By the above-described original reading operation, processing up to filing of the image data of the read original is completed. Next, description will be given for a printing operation when the image data of the read original is printed (formed image) (that is, when the original is copied). When the user operation to perform processing requiring printing is received by the operation panel 30, the main control portion 18 gives an instruction to the recording portion 12, the image storage portion 15, the image processing portion 16, the coding/decoding portion 17, and the like to execute processing as will be described below. Note that, the main control portion 18 also gives an instruction to the reading portion 13 (original reading instruction), for example, when a copy operation is performed.

The coding/decoding portion 17 reads and decodes image data to be printed and original determination data and segmentation data corresponding thereto from the image storage portion 15, which are provided to the image processing portion 16. The image processing portion 16 executes various image processing (hereinafter, referred to as image processing for printing) for the decoded image data (RGB image data). As will be schematically described below, examples of the image processing for printing include image quality adjustment processing, two-color processing, color correction processing, black generation and under color removal processing, spatial filtering processing, scaling processing, output tone correction processing, and halftone generation processing. The black generation and under color removal processing, the spatial filtering processing, and the halftone generation processing are processing in accordance with various areas indicated by the segmentation data.

As the image quality adjustment processing, a background is detected from the decoded image data to perform background removal. Moreover, as the image quality adjustment processing, RGB adjustment (color adjustment; entire color adjustment of redness or blueness), brightness adjustment, and vividness adjustment are also performed for the image data after the application of the background removal based on setting information set by a user from the operation panel 30. At this time, adjustment in accordance with an original type indicated by the original determination data may be performed.

As the color correction processing, CMY data having components of CMY (C: Cyan, M: Magenta, Y: Yellow) which are complementary colors of RGB is generated from the RGB data after the application of the image quality adjustment processing and processing of enhancing color reproduction is performed. As the black generation and under color removal processing, black generation processing of generating black (K) data from the CMY data after the application of the color correction and under color removal processing of subtracting the K data obtained by the black generation from the original CMY data to generate new CMY data.

As the spatial filtering processing, enhancement processing or smoothing processing is performed for CMYK data which is data of the four colors. When a two-color mode for outputting the image data in two colors (for example, red and black) is selected, the two-color processing is performed.

As the two-color processing, processing of converting the RGB data into CMY data that represents specified two colors (red and black in this case) is performed. In the case of the two-color mode, the black generation and under color removal processing is executed for the CMY data after the application of the two-color processing and the spatial filtering processing is also executed, however, the color correction processing is not performed.

As the scaling processing, image enlarging processing or image reducing processing is performed for the CMYK data after the application of the spatial filtering processing based on a printing copy ratio set by the user operation from the operation panel 30. The printing copy ratio is a copy ratio of a printed image for the image indicated by read and stored image data. Of course, the printing copy ratio is not limited to a copy ratio obtained by the user operation and is a copy ratio set as default when no operation is performed for the printing copy ratio.

As the output tone correction processing, output γ correction processing of outputting to a recording medium such as recording paper is performed for the CMYK data. As the halftone generation processing, tone reproduction processing of outputting an image by error diffusion processing and dither processing is performed for the CMYK data after the application of the output tone correction processing. In the output tone correction processing and the halftone generation processing, processing in accordance with an original type indicated by the original determination data may be performed, for example, including differentiating processing contents between a text area and other areas.

The CMYK data after the application of the halftone generation processing is provided to the recording portion 12. The recoding portion 12 receives the image data to which the image processing for printing has been given by the image processing portion 16 in this manner (the CMYK image data in this example) and generates a hard copy (prints out) by an electrophotographic system or an inkjet system. Note that, the data targeted for the printing operation described here is not limited to the image data read by the reading portion 13, and, for example, image data (image file) that has been previously transferred from an external recoding medium, a PC connected through a network, or the like and stored in the image storage portion 15 is also applicable in the same manner. The printing operation for the image data that has been received by facsimile and stored in the image storage portion 15 will be described below.

### <Preview Display Operation for Image Data to be Printed>

Next, description will be given for an operation of displaying a preview of image data stored in the image storage portion 15 as a result of reading an original on the touch panel 32 before printing (preview display operation).

The preview display operation is performed when the user operation to perform processing requiring the preview display is received by the operation panel 30. For example, the preview display operation is also performed, when a setting is made such that a preview of the image data after the original reading is firstly displayed before executing printing.

In an embodiment according to the present invention, when a preview of image data to be printed is displayed, operation input for displaying a finish state of paper for performing image formation is further possible to be received, and when the operation input for displaying a finish state is performed on a screen on which a preview of the image data is displayed, information showing the finish state is displayed on the touch panel 32 separately from the preview image of the image data according to finish conditions set in the digital multi-functional peripheral.

In the preview display operation, the main control portion 18 gives an instruction to the image storage portion 15, the image processing portion 16, the coding/decoding portion 17, the panel control portion 11, and the like to execute processing as will be described below. Note that, the main control portion 18 also gives an instruction to the reading portion 13 (original reading instruction), for example, when an operation of copying an original is performed.

The coding/decoding portion 17 reads and decodes image data to be displayed for previewing and original determination data and segmentation data corresponding thereto from the image storage portion 15, which is provided to the image processing portion 16. The image processing portion 16 executes various image processing (hereinafter, referred to as image processing for previewing) for the decoded image data (RGB image data).

As will be schematically described below, examples of the image processing for previewing include image quality adjustment processing, two-color processing, color correction processing, spatial filtering processing, scaling processing, and output tone correction processing. The spatial filtering processing and the output tone correction processing are processing in accordance with various areas indicated by the segmentation data.

The image quality adjustment processing here is the same as the image quality adjustment processing in the image processing for printing. As the color correction processing, processing of converting the image data after the application of the image quality adjustment processing (RGB data) into R′G′B′ data based on display characteristics of the touch panel 32. As the spatial filtering processing, enhancement processing or smoothing processing is performed for the R′G′B′ data.

As the scaling processing, image enlarging processing/image reducing processing in accordance with a printing copy ratio is applied to the R′G′B′ data after the application of the spatial filtering processing, and processing of converting a pixel number of the R′G′B′ data into a pixel number (display resolution) of the touch panel 32 is performed and image enlarging processing or image reducing processing is performed based on a preview display magnification set by the user operation from the operation panel 30 at the same time. The preview display magnification is a fixed display magnification such as twice and four times, for example, and is a display magnification of an image in the preview display. Of course, the preview display magnification is not limited to a display magnification obtained by the user operation, and is a display magnification set as default when no operation is performed for the preview display magnification.

A preview image generating portion 16a provided in the image processing portion 16 generates an image for the preview display (preview image) mainly by such scaling processing for the preview display.

As the output tone correction processing, output γ correction processing of displaying image data on the touch panel 32 is performed for the R′G′B′ data of the preview image. In the output tone correction processing, processing in accordance with an original type indicated by the original determination data may be performed, for example, including differentiating processing contents between a text area and other areas.

The two-color processing is executed only when a two-color mode for outputting image data in two colors of red and black, for example, is selected. As the two-color processing, processing of converting the RGB data after the application of the image quality adjustment processing into CMY data that represents specified two colors (red and black in this case) is performed. The generated CMYK data is converted into R′G′B′ data based on display characteristics of the touch panel 32 at the subsequent color correction processing.

The R′G′B′ data generated by the preview image generating portion 16a and after the application of the output tone correction processing is provided to the touch panel 32. The panel control portion 11 performs control for the touch panel 32 to display an image corresponding to the R′G′B′ data in a state of being incorporated in a GUI image and displays the GUI image on the touch panel 32.

Note that, the data targeted for the preview display operation described here is not limited to the image data read by the reading portion 13, and image data (image file) that has been previously transferred from an external recording medium, a PC connected through a network, or the like and stored in the image storage portion 15, for example, is also applicable in the same manner.

### <Supplement for Original Reading, Preview Display and Printing>

Although description has been given for the preview display operation separately from the printing operation, the printing operation may be performed such that the image data (CMYK data) after the application of the output tone correction processing is converted into the R′G′B′ data based on display characteristics of the touch panel 32, is processed by conversion processing corresponding to a pixel number (display resolution) of the touch panel 32 and scaling processing corresponding to a reducing/enlarging ratio in the preview display, and is displayed on the touch panel 32. Since the printing operation is completed to a certain extent and the printing operation after the preview display can be completed quickly, it is useful in a case where a setting is made such that a preview is previously displayed, for example, when the copy operation is performed.

In addition, an example in which the coded image data, the original type data and the segmentation data are stored in the image storage portion 15 in association with one another has been taken as the original reading operation, based on which the printing operation and the preview display operation have been also described. As an alternative method thereof, coding may be performed only for the image data read by the reading portion 13, and the coded data may be temporarily stored in the image storage portion 15. In this case, it may be configured such that the image processing portion 16 applies the original type determination processing and the segmentation processing for the image data that has been read from the image storage portion 15 and decoded by the coding/decoding portion 17 in the printing operation and the preview display operation. In addition, such an alternative method is also applicable in sending image data such as sending by facsimile or sending by internet FAX, which will be described below.

### <Facsimile Sending Operation>

Next, description will be given for a sending operation when image data of a read original is sent by facsimile. The facsimile image data is sent to destination (sending destination) information set by the user operation from the touch panel 32 or the key operation portion 31. The destination information (telephone number in this example) is stored in the control memory 19 and is read as necessary. The destination information is generally stored as address book data so that information of a plurality of destinations is viewable and selectable, or is directly input before sending.

When the user operation to execute the facsimile sending is received by the operation panel 30, the main control portion 18 gives an instruction to the image storage portion 15, the image processing portion 16, the coding/decoding portion 17, the NCU 23, the modem 24, and the like to execute processing as will be described below. Note that, the main control portion 18 also gives an instruction to the reading portion 13 (original reading instruction), for example, when the operation to send the original by facsimile is performed. Note that, it is also possible to select image data to be sent and start sending the image data by facsimile while displaying a preview of the image data stored in the image storage portion 15.

The coding/decoding portion 17 reads and decodes image data to be printed, and original determination data and segmentation data corresponding thereto from the image storage portion 15, which is provided to the image processing portion 16. The image processing portion 16 executes various kinds of image processings (hereinafter, referred to as image processing for facsimile sending) for the decoded image data (RGB image data). As will be schematically described below, examples of the image processing for facsimile sending include image quality adjustment processing, spatial filtering processing, scaling processing, output tone correction processing, and halftone generation processing. The spatial filtering processing and the halftone generation processing may be processing in accordance with various areas indicated by the segmentation data, where the segmentation data may not be used. Further, in the original reading operation following the facsimile sending, the segmentation processing for the read image data and coding and storage of the segmentation data may not be executed.

As the image quality adjustment processing, the decoded image data is converted into K data using a matrix coefficient. In this case, a matrix coefficient in accordance with an original type indicated by the original determination data may be used. As the spatial filtering processing, enhancement processing or smoothing processing is performed for the K data. As the scaling processing, image enlarging processing and image reducing processing in accordance with a sending resolution set by the operation panel 30 or a sending resolution set as default are performed for the K data after the application of the spatial filtering processing. As the output tone correction processing, output γ correction processing intended to output to a recording medium such as recording paper at a sending destination, for example, is performed for the K data after the application of the scaling processing. Actually, not output γ correction processing for a device of the sending destination but output γ correction processing for a general device may be performed. As the halftone generation processing, binarization by error diffusion processing, for example, is performed for the K data after the application of the output tone correction processing. In the output tone correction processing and the halftone generation processing, processing in accordance with an original type indicated by the original determination data may be performed.

Description has been given for the facsimile sending of the monochromatic image, but when a color image is sent by facsimile, the image processing portion 16 may perform processing of converting the decoded image data into L*a*b* data for color transmission using a matrix coefficient as the image quality adjustment processing in the above-described image processing for facsimile sending so that the subsequent processing is performed for the L*a*b* data.

The image data after the application of the halftone generation processing is processed by rotating processing as necessary and is compressed and coded by the coding/decoding portion 17 with a compression format for the facsimile sending to be temporarily stored in the image storage portion 15. The modem 24 performs sending procedure to a sending destination set through the NCU 23, and at the time when communication with the sending destination is established (at the time ready for sending), the temporarily stored and coded K data is read and sequentially sent to the sending destination through the public network after necessary processing such as changing of the compression format.

The digital multi-functional peripheral 1 of the present invention is capable of sending image data to be sent with additional information such as transmission source information added thereto. The additional information added to the image data is an additional image. The additional information may be stored in the control memory 19. In addition, more than one piece of additional information may be stored in the control memory 19 and additional setting information may be stored in the control memory 19. The additional setting information at least includes information showing a position to add to the image data to be sent (hereinafter, referred to as an adding position), and when more than one piece of additional information is stored, information for selecting which piece of information is also included.

In the case of the facsimile sending with additional information added, synthesizing processing may be performed as follows. The main control portion 18 reads additional information and information showing an adding position, which is converted into image data by the main control portion 18 or the image processing portion 16, and the image processing portion 16 synthesizes the converted image data (image data of additional information) at the above-described adding position in image data of the adding destination which is image data after the application of the scaling processing. In the digital multi-functional peripheral 1 of the present invention, the position at which the image data of the additional information is added to the image data after the application of the scaling processing is defined as being settable by a user from the operation panel 30 while performing the preview display as will be described below. The synthesized image data is processed by the above-described output tone correction processing, rotating processing, and compression processing, etc., and thereafter sent to the sending destination.

### <Preview Display Operation for Image Data to be Sent by Facsimile>

It is essential that the digital multi-functional peripheral 1 of the present invention has a configuration allowing image data to be sent by facsimile sending or the like to be displayed for previewing. The preview display operation is performed, for example, when the previous setting or the user operation to execute sending after confirming the image data before sending in advance is performed. Description will be given for the preview display operation for the image data to be sent by facsimile based on the facsimile sending operation for the same image data. In the preview display operation, the main control portion 18 also gives an instruction to the panel control portion 11.

In the preview display operation, the image processing portion 16 may perform the same processing as in the facsimile sending up to the image quality adjustment processing, the spatial filtering processing, and the scaling processing, and the preview image generation processing may be executed by the preview image generating portion 16a and the output γ correction processing for displaying the image data may be performed as the output tone correction processing. As the preview image generation processing, the preview image generating portion 16a performs conversion processing in accordance with a pixel number (display resolution) of the touch panel 32 and scaling processing in accordance with a reducing/enlarging ratio in the preview display for image data after the application of the image enlarging processing and the image reducing processing in accordance with a sending resolution to thereby generate data of the preview image. Note that, in the preview display operation, the spatial filtering processing may not be executed and the halftone generation processing is not executed.

R′G′B′ data generated by the preview image generating portion 16a and after the application of the output tone correction processing is provided to the touch panel 32. The panel control portion 11 performs control for the touch panel 32 to display an image corresponding to the R′G′B′ data in a state of being incorporated in a GUI image to display the GUI image on the touch panel 32.

### <Sending Operation for Image Data via Internet>

Next, description will be given for a sending operation when image data of a read original is sent by an electronic mail or internet FAX via the internet. Such image data to be sent via the internet is also sent to sending destination information (electronic mail address in this example) set by the user operation from the touch panel 32 or the key operation portion 31 and stored in the control memory 19.

When the user operation concerning the sending via the internet is received by the operation panel 30, the main control portion 18 gives an instruction to the format converting portion 14, the image storage portion 15, the image processing portion 16, the coding/decoding portion 17, the LAN control portion 21, and the like to execute sending processing via the internet as will be described below. Note that, the main control portion 18 also gives an instruction to the reading portion 13 (original reading instruction), for example, when an operation to send an original via the internet is performed.

The coding/decoding portion 17 reads and decodes image data to be printed and original determination data and segmentation data corresponding thereto from the image storage portion 15, which is provided to the image processing portion 16. The image processing portion 16 executes various kinds of image processings (hereinafter, referred to as image processing for internet sending) for the decoded image data (RGB image data). Examples of the image processing for internet sending include the image quality adjustment processing, the spatial filtering processing, the scaling processing, the output tone correction processing, and the halftone generation processing, which have been described in the image processing for facsimile sending.

Moreover, the image processing in the case of color image sending is also the same as the image processing for facsimile sending, and in the image processing for internet sending, the image processing portion 16 may perform processing of converting the decoded image data into L*a*b* data for color transmission using a matrix coefficient as the image quality adjustment processing so that the subsequent processing is performed for the L*a*b* data.

The coding/decoding portion 17 codes (compresses) the image data after the application of the image processing for internet sending to obtain compressed files. The compression is performed in the unit of a single page of the original. Subsequently, the format converting portion 14 converts the compressed files into a single file and the file is attached to a multipart mail according to MIME (Multipurpose Internet Mail Extension), for example. By the processing so far, the read image data is converted into a format of an electronic mail. The electronic mail is sent to a sending destination via the internet using a mail transfer protocol such as an SMTP (Simple Mail Transfer Protocol) through a LAN interface by the LAN control portion 21.

In the case of the internet facsimile sending, the coding/decoding portion 17 may perform the compression in a compression format only for facsimile such as MH, for example, and the format converting portion 14 may convert the obtained compressed files in the unit of a page, for example, into a single TIFF file. In the case of sending just by attaching to the electronic mail as an attached file (in the case of sending by so-called scan to e-mail), the coding/decoding portion 17 may perform the compression in a compression format such as JPEG, for example, and the format converting portion 14 may convert the obtained compressed files in the unit of a page into a single PDF file, for example.

In addition, even when image data to be sent is image data sent via the internet, the digital multi-functional peripheral 1 of the present invention is capable of sending the image data with additional information such as transmission source information added thereto in the same manner as the case of the facsimile sending image data. As the additional information adding processing, the synthesizing processing described in the facsimile sending may be executed, and the image data is after the application of the output tone correction processing, the compression processing, the format conversion processing, and the like described above and thereafter sent to an address of a sending destination as an electronic mail.

### <Preview Display Operation for Image Data to be Sent via Internet>

As well as mentioned in the description for the preview display in the facsimile sending, the digital multi-functional peripheral 1 of the present invention can be configured so that a preview of image data to be sent via the internet can also be displayed on the touch panel 32.

In the preview display operation, as mentioned in the description for the preview display in the facsimile sending, the image processing portion 16 may perform the same processing that as in the image processing for internet sending up to the image quality adjustment processing, the spatial filtering processing, and the scaling processing, and the preview image generation processing may be executed by the preview image generating portion 16a, and the output γ correction processing for displaying the image data may be performed as the output tone correction processing. R′G′B data generated by the preview image generating portion 16a and after the application of the output tone correction processing is provided to the touch panel 32 and is displayed on the touch panel 32 in a state of being incorporated in a GUI image by the panel control portion 11. The description for the preview display in the facsimile sending may be also quoted for synthesizing of information showing an adding position or additional information.

### <Description for Preview Display Before Sending Image Data>

As has been described for the preview display operation in the facsimile sending and in the image data sending via the internet, the digital multi-functional peripheral 1 according to the present invention has the preview image generating portion 16a that reads at least image data to be sent from the image storage portion 15 and generates a preview image thereof. The preview image generated by the preview image generating portion 16a is sent to the touch panel 32 by the control from the main control portion 18, controlled to be displayed in a state of being incorporated in a GUI image by the panel control portion 11, and displayed on the touch panel 32. In this manner, the touch panel 32 is an example of an image display portion that displays a preview of the image data to be sent.

### <Description for Preview Display According to the Present Invention>

The digital multi-functional peripheral 1 has a preview image generating portion 16a that reads image data for performing image formation from the image storage portion 15 and generates a preview image thereof. The preview image generated by the preview image generating portion 16a is sent to the touch panel 32 by control from the main control portion 18, controlled to be displayed in a state of being incorporated in a GUI image by the panel control portion 11, and displayed on a display portion of the touch panel 32. The touch panel is an example of the display portion that displays a preview of image data targeted for image formation.

As described above, in the digital multi-functional peripheral 1 of the present invention, the panel control portion 11 performs control for the image data displayed for previewing to display information showing a finish state on the touch panel based on the control from the main control portion 18. In this case, the preview image of the image data is displayed with a reduced image for each page and the information showing the finish state is displayed on the same screen separately from the image data.

The preview image generating portion 16a generates the preview image from the information showing the finish state and the image data targeted for image formation. Each of the preview image generating portion 16a and the panel control portion 1 is one example of a display control portion that performs control to display the information showing the finish state in the preview display.

An example of the information showing the finish state include information related to staples and punch holes applied to paper for performing image formation or information related to inter-leaves for inserting different kinds of sheets of paper or the like in a predetermined position for performing image formation, information related to OHP inter-leaves for inserting different kinds of sheets of paper (protection paper) between sheets of OHP paper, information related to a front cover for inserting different kinds of sheets of paper or the like in a top page position for performing image formation, and information related to a back cover for inserting similarly different kinds of sheets of paper or the like in the last page position.

It is possible for a user to confirm the preview image in which a reduced image for each page of the image data and the information showing the finish state are displayed, determine whether to directly execute or stop the image formation or whether to execute changing of an output setting or the like, and perform an operation corresponding thereto.

In this manner, in the embodiment according to the present invention, when a preview display of image data for performing image formation is executed, information showing a finish state of the image formation can be displayed separately from a preview image of the image data. Accordingly, the user is able to perform the image formation after confirming contents of the finish state accurately, thus it is possible to prevent from performing unnecessary image formation (printing) due to setting errors by the user.

### <Specific Example of Preview Display>

Description will hereinafter be given for information showing a finish state that is displayed together with a preview image of image data and for the flow of a preview display thereof with reference to specific examples. The following example of a screen display shows an exemplary display of the touch panel in the digital multi-functional peripheral 1 according to an embodiment of the present invention.

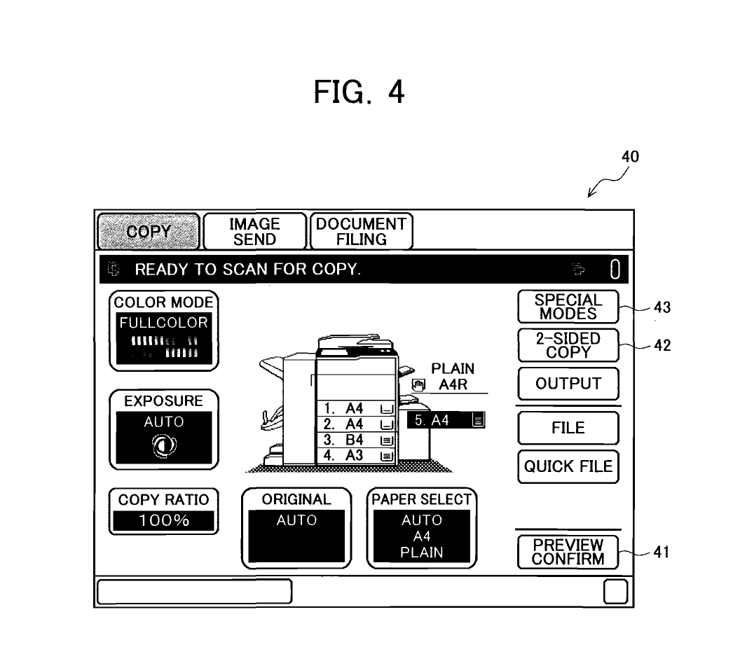

FIG. 4 is a diagram for showing an example of a standard screen of the digital multi-functional peripheral. A standard screen 40 is displayed on the touch panel 32 of the digital multi-functional peripheral 1 when a power source of the digital multi-functional peripheral 1 is turned on or reset. On the standard screen 40, various conditions settings for performing a copy are possible. A preview confirm key 41 is displayed on the standard screen 40, and the user is able to display a preview of image data by operating the preview confirm key 41 using the touch panel 32.

The image data displayed for previewing in this case is image data of an original image read by the reading portion 13 (FIG. 2) and stored in the image storage portion 15. In addition, image data received from an external device by facsimile, internet FAX, or the like and stored in the image storage portion 15 can also be a target for the preview.

For example, when trying to copy an original, the user sets the original on the reading portion 13 and firstly operates the preview confirm key 41. Then, by pressing the start key 31d (FIG. 3) to start the copy, the original image is read and a preview of image data stored in the image storage portion 15 is displayed. Alternatively, when performing an operation of printing image data received from an external device, the preview confirm key 41 is operated and the start key 31d is then pressed so that a preview of the image data can be displayed.

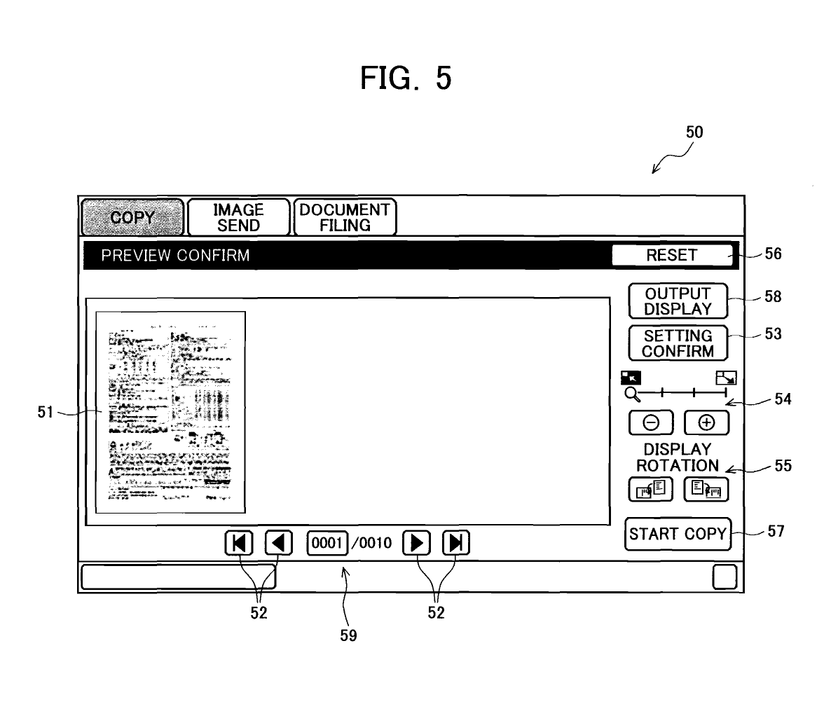

FIG. 5 is a diagram for showing an example of a display screen when a preview confirm key is operated on the standard screen of FIG. 4. When a user operates the preview confirm key 41 on the standard screen 40, a preview screen 50 is displayed as shown in FIG. 5. On the preview screen 50, a preview image 51 of image data to be printed is displayed. The preview image 51 is displayed by performing image processing for a preview as described above for the image data, which shows reduced image data for each page. The preview image 51 is displayed for each page in this manner and the user is able to display an arbitrary page of the preview image by operating a page switch key 52 as appropriate. It is also possible to confirm a currently displayed page of the image data by a page display 59.

Moreover, a setting confirm key 53, an enlarging/reducing key 54, a display rotation key 55, and the like are displayed on the preview screen 50, and by operating these keys appropriately, the user is able to confirm a setting of the preview image 51 or to confirm by enlarging, reducing or rotating the preview image 51. When a necessity of setting print conditions arises again by confirming the preview image 51, the user is able to open a screen for setting the print conditions again by operating a reset key 56. Then, it is possible to reset the print conditions using the reset screen to display the preview image 51 based on the reset print conditions.

In addition, a copy start key 57 is displayed on the preview screen 50 shown in FIG. 5, and when the user operates the copy start key 57, processing for performing image formation (printing) of the image data displayed for previewing is started.

On the preview screen 50 shown in FIG. 5, an output display key 58 for displaying a finish state which is a characteristic of the embodiment according to the present invention is displayed.

By operating the output display key 58 in a state where the preview image 51 of the image data is displayed on the preview screen 50, the user is able to confirm the finish state after printing as a preview. Preview information of the finish state is displayed as information different from the preview image 51 of the image data. A specific exemplary display of the finish state will be described below.

The digital multi-functional peripheral 1 displays the output display key 58 in an active state only when predetermined output processing is set to a copy job of image data (job of image formation) on the preview screen 50. As the predetermined output processing, for example, 2-sided printing processing, staple processing, punch processing, inter-leaf insertion processing, OHP inter-leaf insertion processing, or the like can be set.

For example, a selecting operation by the user is possible in an active state, while in an inactive state, the active state can be identified by displaying the display in a grayed out manner or deleting the display.

After the user operates the output display key 58 in an active state to display information showing the finish state, by operating the output display key 58 again, the original preview screen 50 as shown in FIG. 5 can be returned.

That is, when the information showing the finish state is displayed together with the preview image of the image data on the display portion of the touch panel 32, if an operation of selecting the output display key 58 is performed again, the display control portion (the preview image generating portion 16a and the panel control portion 11) of the digital multi-functional peripheral 1 performs control to return to a display state in which the preview image of the image data is displayed and the information showing the finish state is not displayed.

Alternatively, when the display showing the finish state is displayed on the display portion, if an operation of selecting the output display key 58 is performed again, the display control portion controls to delete at least the display showing the finish state that is displayed on the display portion of the touch panel 10.

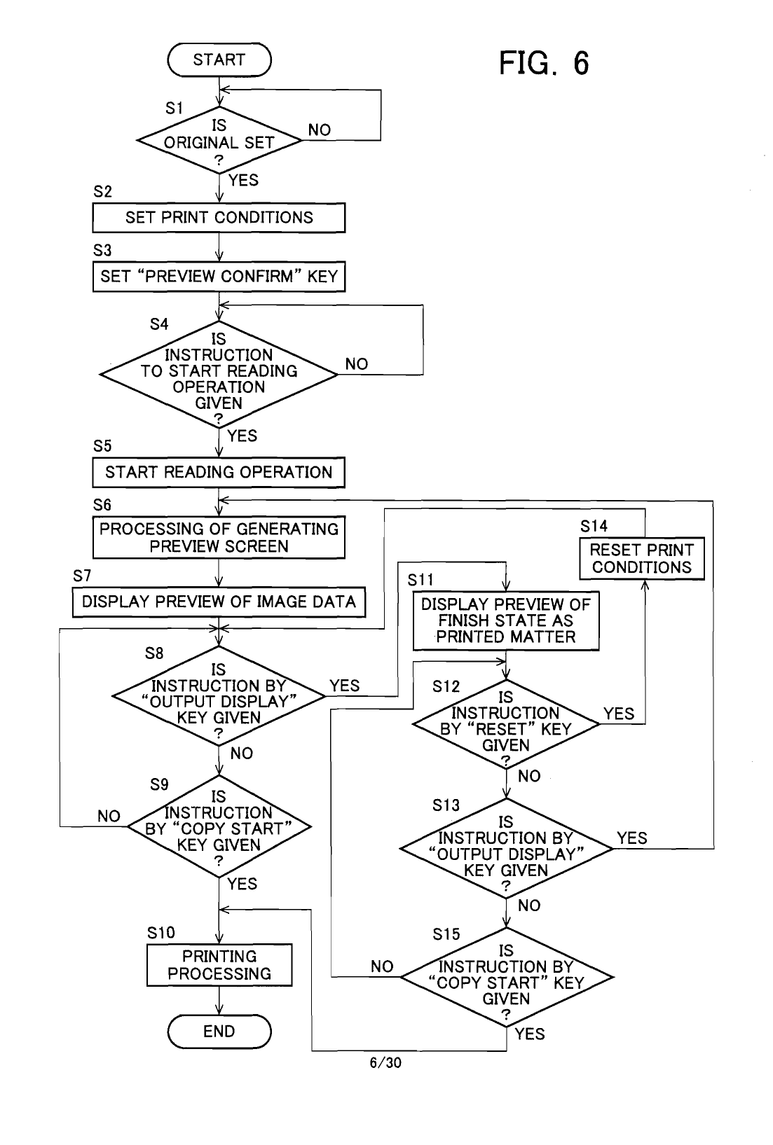

FIG. 6 is a flowchart for explaining an example of preview display processing in the digital multi-functional peripheral of the above-described embodiment. Here, description will be given for exemplary processing when an original image targeted for printing (image formation) is read to display a preview thereof, with reference to the preview screen of FIG. 5.

First, when an original to be printed is set (step S1-Yes), the digital multi-functional peripheral sets print conditions (step S2). In this case, printing according to the print conditions can be performed if there is no change in the print conditions that have been already set, alternatively, if the setting is changed by the user, the changed print conditions are set.

Subsequently, the digital multi-functional peripheral performs a setting of the preview confirm key (step S3). When the preview confirm key 41 is operated by the user before a copy is started, it is set in the digital multi-functional peripheral such that a preview image is displayed after image data is read. When an instruction to start a reading operation is given by the user (step S4-Yes), the reading operation of the original image is started (step S5).

Then, the digital multi-functional peripheral performs processing of generating a preview image of the read image data (step S6) and displays a preview of the image data (step S7).

Further, the digital multi-functional peripheral determines whether an instruction by the output display key 58 is given in a state where the preview image is displayed (step S8). When no instruction by the output display key 58 is given, it is determined whether an instruction to start the copy by the copy start key 57 is given (step S9), and when the instruction to start the copy is given, printing processing for the image data is started (step S10). Alternatively, when no instruction to start the copy is given, the procedure returns to step S8 to determine whether the instruction by the output display key 58 is given.

When the instruction by the output display key 58 is given at step S8, the digital multi-functional peripheral performs a preview display of a finish state as a printed matter (step S11). When an instruction by the reset key 56 is given while information showing the finish state is displayed (step S12-Yes), the print conditions are reset in accordance with the subsequent user operation (step S14) and the procedure returns to step S8. Alternatively, when no instruction by the reset key 56 is given (step S12-No) and the instruction by the output display key 58 is given again (step S13-Yes), the procedure returns to step S7 to perform a preview display.

Alternatively, when no instruction by the output display key 58 is given (step S13-No) and the instruction to start the copy by the copy start key 57 is given (step S15-Yes), the procedure proceeds to step S10 to perform printing processing of the read image data. When no instruction to start the copy is given, the procedure returns to step S12.

Next, description will be given for a specific exemplary display of information showing a finish state to be displayed on a preview screen.

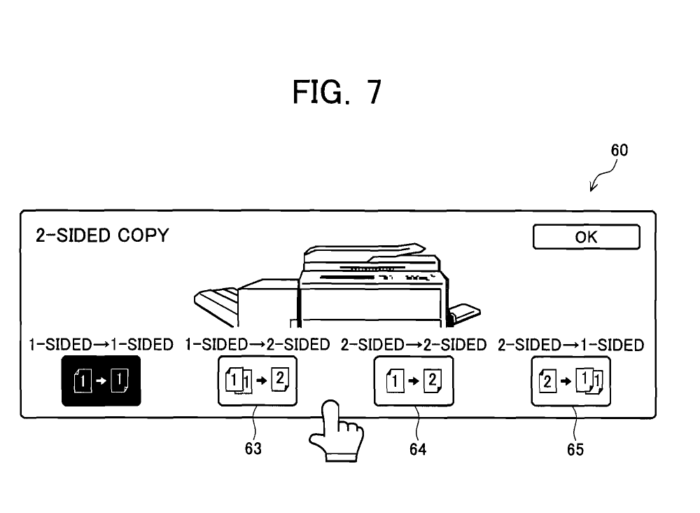

FIG. 7 is a diagram for showing an example of a setting screen of 2-sided printing in the digital multi-functional peripheral. When a 2-sided copy key 42 is operated on the standard screen 40 of the digital multi-functional peripheral as shown in FIG. 4, a setting screen of 2-sided copy 60 as shown in FIG. 7 can be opened. Here, by operating a “1-sided to 2-sided” key 63 for setting an automatic 2-sided copy from a 1-sided original, a “2-sided to 2-sided” key 64 for setting an automatic 2-sided copy from a 2-sided original, a “2-sided to 1-sided” key 65 for setting a 1-sided copy from a 2-sided original, or the like, the user is able to set a desired 2-sided copy.

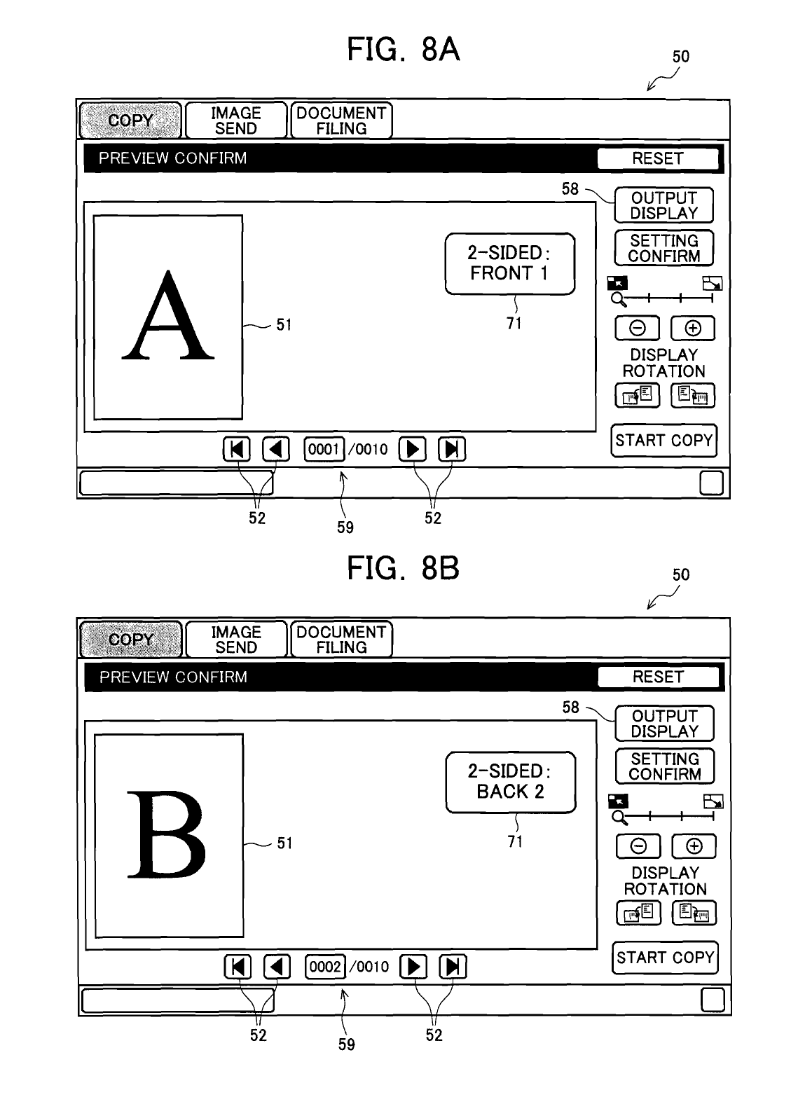

FIGS. 8A and 8B are diagrams for showing an exemplary display of information related to 2-sided printing processing as an example of a finish state. The user is able to display a preview image of image data by setting print conditions and operating the preview confirm key 41 on the standard screen shown in FIG. 4. The display screen in this case is, for example, the preview screen 50 as shown in FIG. 5. By operating the output display key 58 on the preview screen 50, information showing a finish state (hereinafter, referred to as finish state information) 71 as shown in FIGS. 8A and 8B can be displayed for previewing.

On the preview screen 50, the finish state information 71 concerning 2-sided printing processing is displayed together with the preview image 51. The preview image 51 is a reduced image of image data to be printed as described above and is displayed for each page. The finish state information 71 is displayed in the same screen separately from the preview image 51 for each page.

FIG. 8A shows a screen that displays image data of a front side serving as a first page in 2-sided printing. Here, image data on the front side serving as a first page in 2-sided printing is shown (indicated by “A” in the figure) as the preview image 51. “2-sided: Front 1” is displayed as the finish state information 71. This display allows the user to recognize that a 2-sided printing setting is performed and image data of the current preview image 51 is the front side of the first page in the 2-sided setting. It is also possible to confirm the current page number by the page display 59.

FIG. 8B shows a screen that displays image data of a back side serving as the second page in 2-sided printing (indicated by B in the figure). For example, by operating the page switch key 52 in the state of FIG. 8A, the user is able to display the preview image 51 of a next page (second page). In this case, “2-sided: Back 2” is displayed as the finish state information 71. This display allows the user to recognize that a 2-sided printing setting is performed and the image data of the current preview image 51 is the back side of a second page in the 2-sided setting.

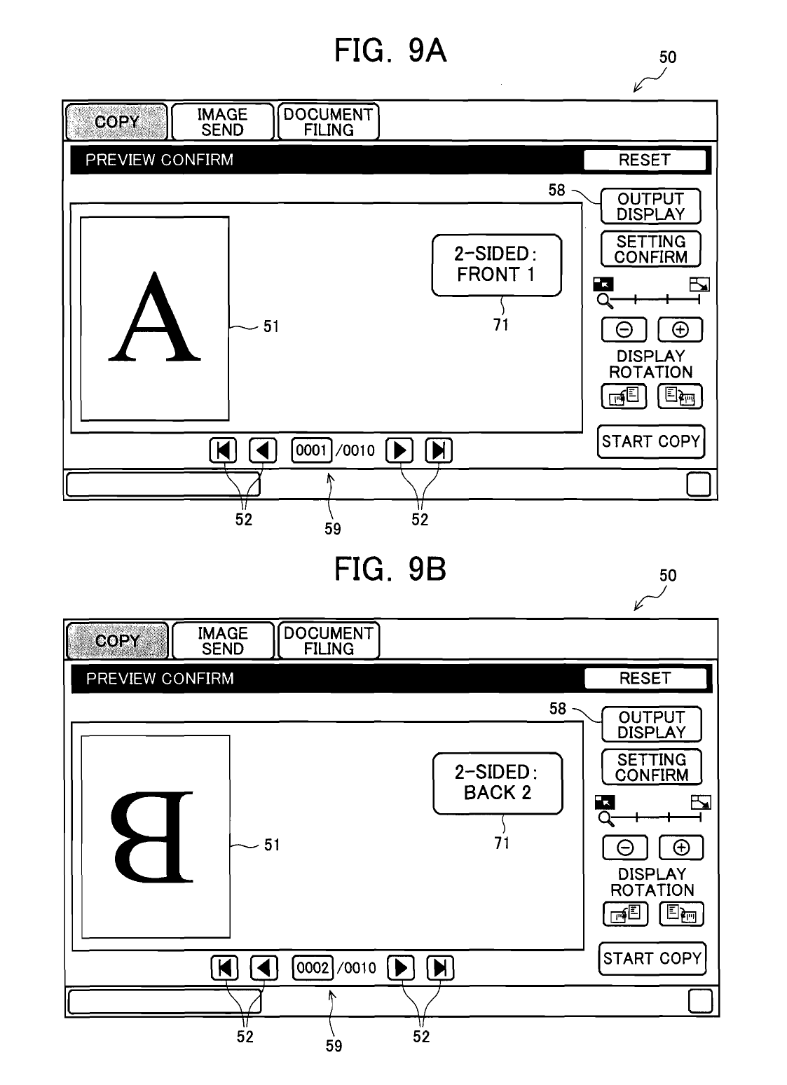

FIGS. 9A and 9B are diagrams for showing another exemplary display of information related to 2-sided printing as an example of a finish state. Although the exemplary display of FIGS. 9A and 9B is the same as the exemplary display of FIGS. 8A and 8B concerning a 2-sided printing setting, the 2-sided printing setting is different from the example of FIGS. 8A and 8B and the preview image 51 is displayed correspondingly thereto. That is, in FIGS. 9A and 9B, a direction switch of 2-sided printing is turned on and it is set such that a print direction of the back side is upside down compared to that of the front side in output. In this case, although the preview screen 50 on the front side of FIG. 9A is the same as in FIG. 8A, the preview image 51 is upside down on the preview screen 50 of the back side shown in FIG. 9B. This makes it possible for the user to confirm that the direction switch is turned on and to confirm a finish state by the finish state information 71.

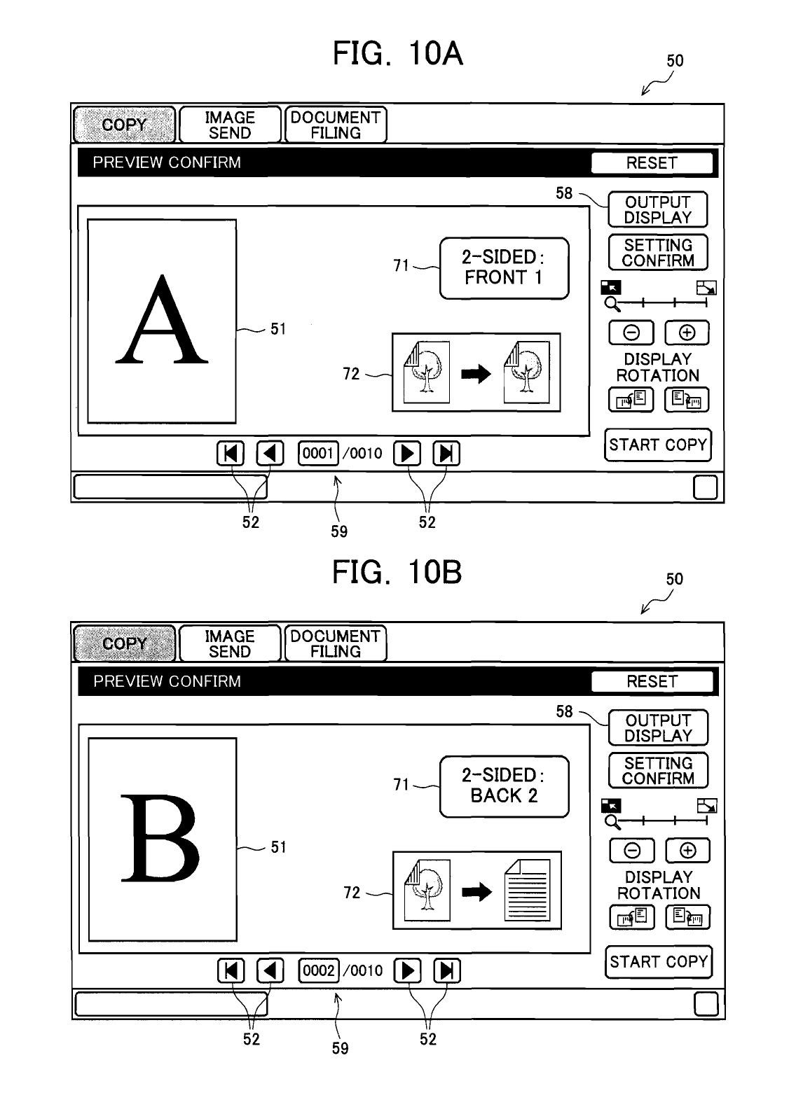

FIGS. 10A and 10B are diagrams for showing still another exemplary display of information related to 2-sided printing as an example of a finish state. In the exemplary display of FIGS. 10A and 10B, an icon 72 showing a finish state is displayed at the same time in addition to the finish state information 71 as shown in FIGS. 8A and 8B and FIGS. 9A and 9B.

FIG. 10A shows a preview display screen of a front side in 2-sided printing, where image data on the front side serving as the first page in 2-sided printing (“A”) is shown as the preview image 51 and “2-sided: Front 1” is displayed as the finish state information 71. In addition thereto, the icon 72 showing to be the front side in 2-sided printing is displayed at the same time. The icon 72 is previously prepared in accordance with a printing setting and held by the digital multi-functional peripheral, and the display control portion selects and displays the icon 72 in accordance with the image data to be previewed and the printing setting.

This display allows the user to recognize that a 2-sided printing setting is performed and the image data of the current preview image 51 is the front side of a first page in the 2-sided setting.

FIG. 10B shows a screen that displays image data of a back side serving as a second page in 2-sided printing (“B”), and “2-sided: Back 2” is displayed as the finish state information 71. The icon 72 showing to be the back side in 2-sided printing is further displayed at the same time.

This display allows the user to recognize that a 2-sided printing setting is performed and image data of the current preview image 51 is the back side of a second page in the 2-sided setting.

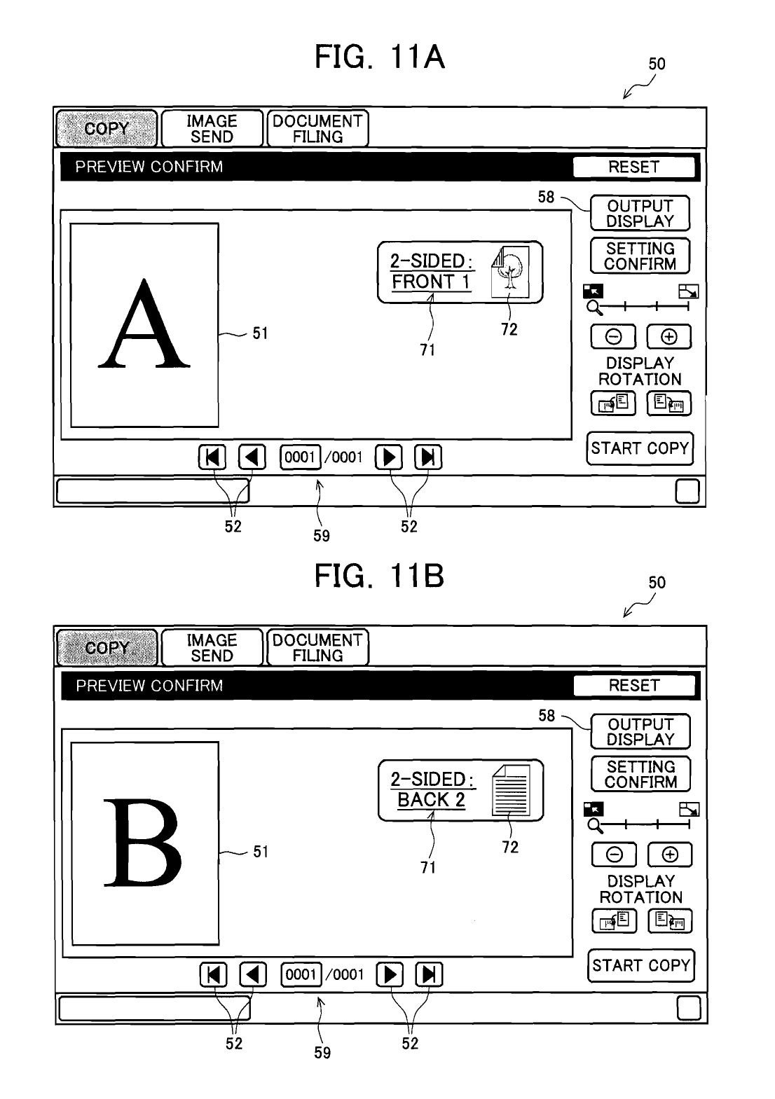

FIGS. 11A and 11B are diagrams for showing still another exemplary display of information related to 2-sided printing as an example of a finish state. Although the icon 72 showing a finish state is displayed at the same time in addition to the finish state information 71 similarly to FIGS. 10A and 10B in the exemplary display of FIGS. 11A and 11B, a display form thereof is different.

FIG. 11A shows a preview display screen of a front side in 2-sided printing, where image data on the front side serving as the first page in 2-sided printing (“A”) is shown as the preview image 51 and “2-sided: Front 1” is displayed as the finish state information 71. In addition thereto, the icon 72 showing to be the front side in 2-sided printing is displayed at the same time. The icon 72 and the finish state information 71 are displayed side by side in this example.

This display allows the user to recognize that a 2-sided printing setting is performed and image data of the current preview image 51 is the front side of a first page in the 2-sided setting.

FIG. 11B shows a screen that displays image data of a back side serving as the second page in 2-sided printing (“B”), and “2-sided: Back 2” is displayed as the finish state information 71. The icon 72 showing to be the back side in 2-sided printing is further displayed at the same time. This display allows the user to recognize that a 2-sided printing setting is performed and image data of the current preview image is the back side of a second page in the 2-sided setting.

As in each example described above, by displaying the finish state information 71 showing a finish state and the icon together with the preview image 51, the user is surely able to confirm the finish state on the preview screen. At this time, since the finish state information 71 and the icon 72 are displayed separately from the preview image 51 without displaying the finish state directly on the preview image 51, the user is able to confirm without causing errors and confusion in the preview image 51. Further, the finish state information includes page information showing the current page so that the user is surely able to recognize information of that page. Such processing surely enables unnecessary image formation processing due to setting errors by the user to be prevented. The similar effect is also obtained in the following another embodiment.

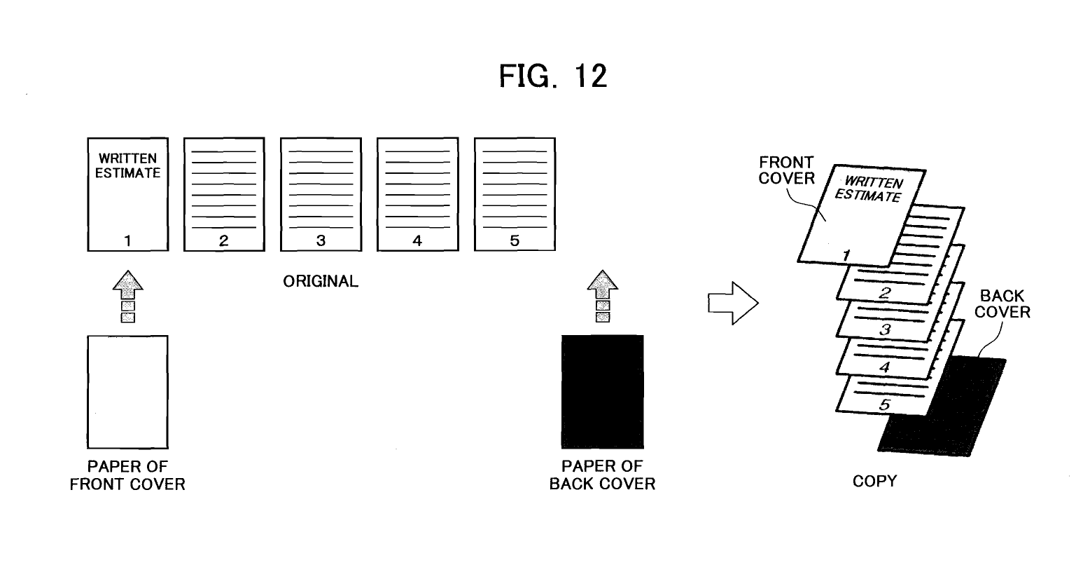

FIG. 12 is a diagram for explaining a cover setting in the digital multi-functional peripheral. The cover setting is to set processing of inserting different kinds of papers or the like to the first or last page position in printing (performing image formation of) image data. In the case of inserting to the first page, the paper serves as a front cover, and in the case of inserting to the last page, the paper serves as aback cover. It is possible to perform printing on the front cover and the back cover and it is also possible just to insert the paper without performing printing. The illustrated example shows a case where the first page of a five-page original is printed on a front cover of the different paper and a back cover on which no printing is performed is inserted after the last page of five-page original.

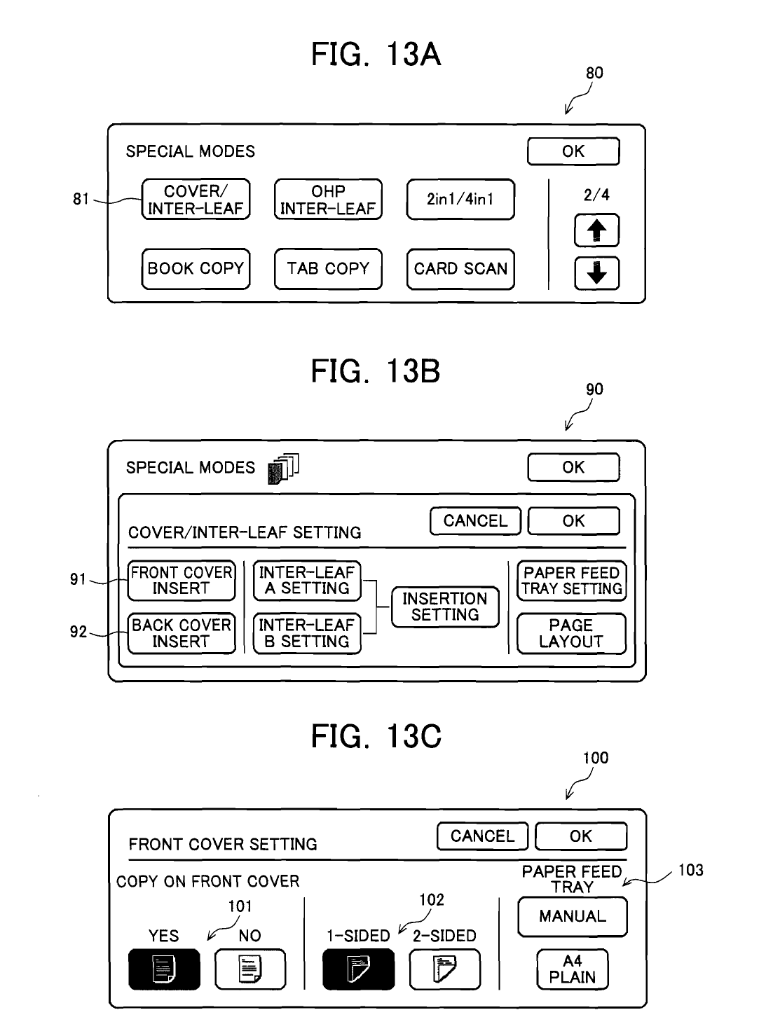

FIGS. 13A to 13C are diagrams for showing a display screen for a cover setting in the digital multi-functional peripheral.

When a special modes key 43 is operated on the standard screen 40 of the digital multi-functional peripheral as shown in FIG. 4, a predetermined special modes setting screen 80 as shown in FIG. 13A can be opened. By pressing a cover/inter-leaf key 81, the user is able to open a cover/inter-leaf setting screen 90 as shown in FIG. 13B.

Here, it is possible to perform various settings for a front cover and a back cover. For example, the screen of FIG. 13B is provided with a setting key 91 for inserting a front cover and a setting key 92 for inserting a back cover so that a setting of a front cover and a setting of a back cover are possible individually. For example, when the front cover setting key 91 is operated in FIG. 13B, a front cover setting screen 100 as shown in FIG. 13C is opened. A copy setting key 101 for setting whether or not to perform a copy on a front cover itself, a 1-sided/2-sided setting key 102 for setting whether to perform a copy on a front cover in a 1-sided or 2-sided manner, and a tray selection key 103 for selecting a tray for feeding sheets of a front cover are provided so that settings related to printing of a front cover can be performed properly.

It is also possible to perform settings in the same manner when a back cover insertion is selected in FIG. 13B.

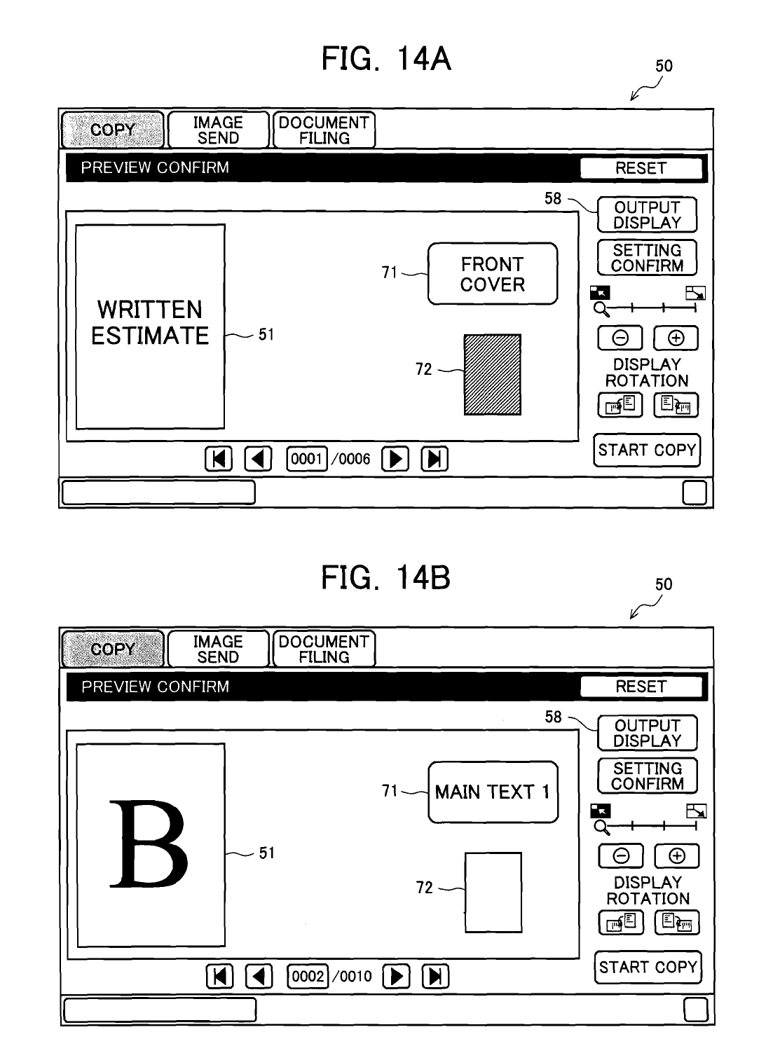

FIGS. 14A to 14C are diagrams for showing an exemplary display of information related to front cover/back cover insertion processing as another example of a finish state. Similarly to the above-described example, by setting print conditions and operating the preview confirm key 41 on the standard screen 40 of FIG. 4, the user is able to display a preview of image data. By operating the output display key 58 on the preview screen 50 that displays the preview, the finish state information 71 as shown in FIGS. 14A to 14C can be displayed.

In this case, the finish state information 71 concerning front cover insertion processing is displayed together with the preview screen 51 on the preview screen 50. The preview image 51 is a reduced image of image data to be printed as described above and is displayed for each page.

FIG. 14A shows a preview display screen of a front cover. Here, image data of a front cover serving as the first page in printing is displayed as the preview image 51 (indicated by “written estimate” in the figure). “Front cover” is displayed as the finish state information 71.

Moreover, the icon 72 showing a finish state is displayed together with the finish state information 71 on the preview screen 50. The icon 72 is previously prepared in accordance with a printing setting and held by the digital multi-functional peripheral, and the icon 72 showing a front cover is displayed.

This display allows the user to recognize that a front cover insertion setting is performed and image data of the current preview image 51 is the front cover side. Since the front cover is naturally the first page, the expression “front cover” itself shows page information.

FIG. 14B shows a screen that displays image data serving as the second page in inserting a front cover (indicated by “B” in the figure). In this case, “Main text 1” is displayed as the finish state information 71. In addition, the icon 72 showing being the main text is displayed as the icon 72 showing a finish state.

This display allows the user to recognize that a front cover insertion setting is performed and image data of the current preview image 51 is the first page of the main text subsequent to the front cover.

FIG. 14C shows a screen that displays image data of a back cover (which is not printed here). In this case, “Back cover” is displayed as the finish state information 71. Moreover, the icon 72 showing being the back cover is displayed as the icon 72 showing a finish state. This display allows the user to recognize that a back cover insertion setting is performed. Since the back cover is naturally inserted in the last page, the expression “back cover” itself shows page information.

Note that, although the icon 72 showing a finish state is displayed in addition to the finish state information 71 on the above-described preview screen, only the finish state information 71 may be displayed together with the preview image 51.

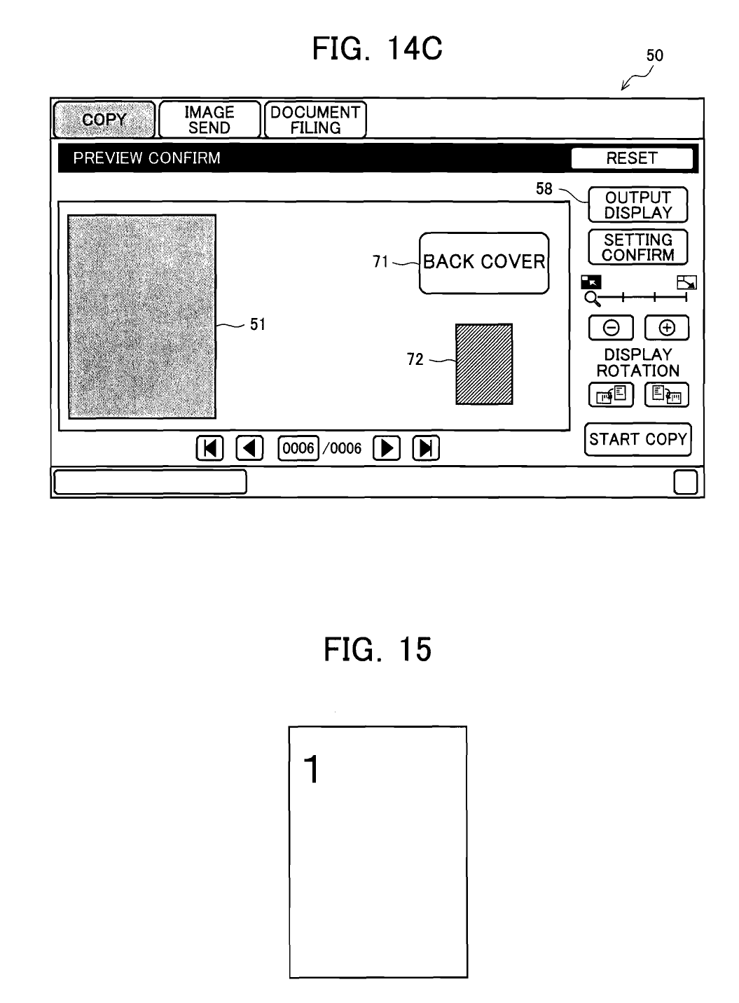

Moreover, the icon 72 showing finish state information may be an icon describing page information, for example, as shown in FIG. 15. In this example, the icon shows being the first page of the main text or the first page including a front cover. These display rules are determined in advance.

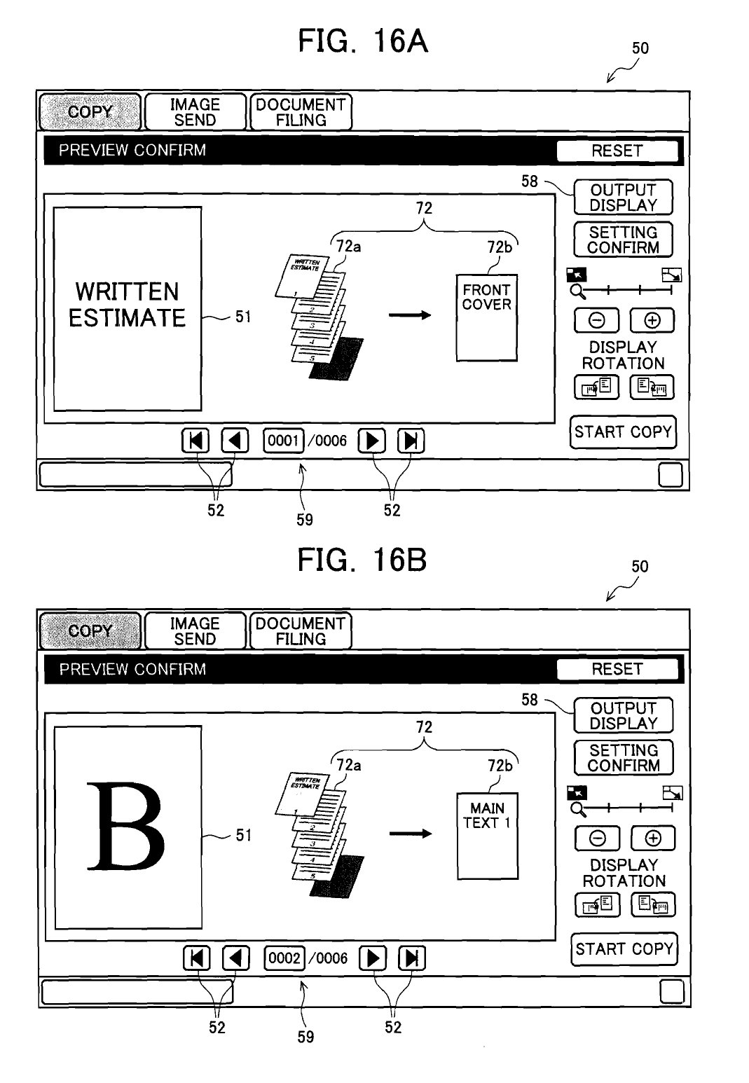

FIGS. 16A and 16B are diagrams for showing another exemplary display of information related to front cover/back cover insertion processing as another example of a finish state. Similarly to the above-described example, by setting print conditions and operating the preview confirm key 41 on the standard screen 40, the user is able to display a preview of image data. By operating the output display key 58 on the preview screen 50, the icon 72 showing a finish state as shown in FIGS. 16A and 16B can be displayed for previewing.

In this case, the icon 72 showing finish state information concerning front cover insertion is displayed together with the preview image 51 on the preview screen 50.

FIG. 16A shows a preview display screen of a front cover. Here, image data of a front cover serving as the first page in printing (“written estimate”) is shown as the preview image 51. An icon 72a showing an arranging state of pages after printing in a model manner and an icon 72b showing that a front cover is currently shown among them are displayed as the icon 72 showing a finish state. This display allows the user to recognize that a front cover and back cover insertion setting is performed and image data of the current preview image 51 is the front cover side. It is also possible to recognize page information by the display of a front cover.

FIG. 16B shows a screen that displays image data serving as the second page in inserting a front cover (“B”). The icon 72a showing an arranging state of pages after printing in a model manner and the icon 72b showing that the first page of the main text is currently shown among them are displayed as the icon 72 showing a finish state. This display allows the user to recognize that a front cover and back cover insertion setting is performed and image data of the current preview image 51 is the first page of the main text.

Note that, although the icon 72 showing a finish state is displayed on the above-described preview screen, the finish state information 71 as shown in FIGS. 14A to 14C may be displayed in addition thereto.

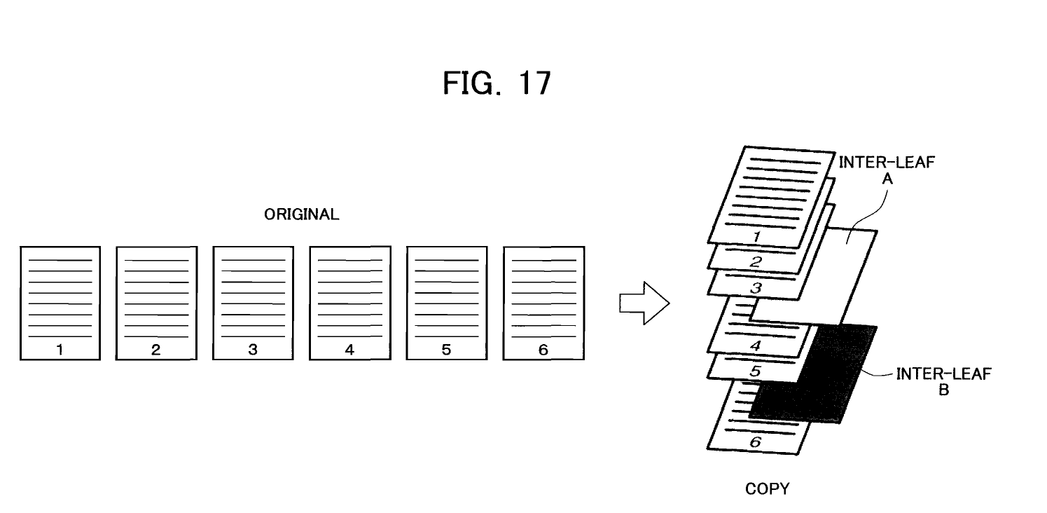

FIG. 17 is a diagram for explaining an inter-leaf setting in the digital multi-functional peripheral. The inter-leaf setting is to set processing of inserting different kinds of sheets of paper or the like to a predetermined position in printing (performing image formation of) image data. The different sheet of paper or the like inserted in the top page serves as a front cover and the different sheet of paper or the like inserted in the last page serves as a back cover, while insertion of the sheet of paper in the middle of the main text corresponds to inter-leaf processing. It is possible to perform printing on the inter-leaf and it is also possible just to insert the paper without performing printing. The illustrated example shows a case where inter-leaves (A, B) are inserted after the page three and after the page five of six-page original.

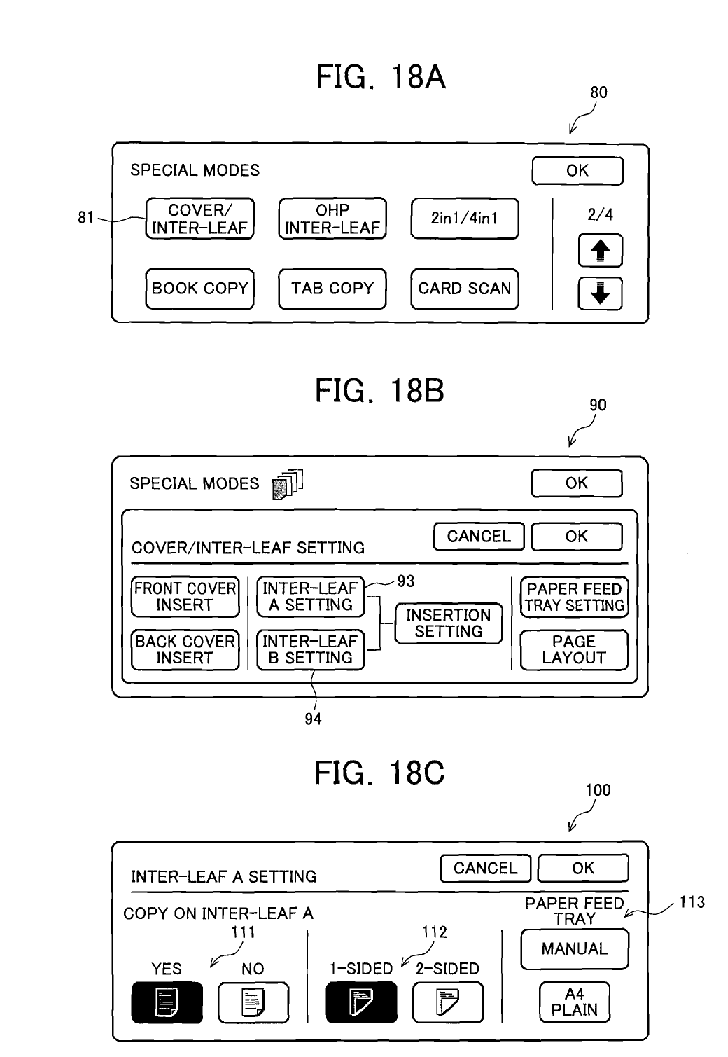

FIGS. 18A to 18C are diagrams for showing a display screen for an inter-leaf setting in the digital multi-functional peripheral.

When the special modes key 43 is operated on the standard screen 40 of the digital multi-functional peripheral as shown in FIG. 4, the predetermined special modes setting screen 80 as shown in FIG. 18A is able to be opened. By depressing the cover/inter-leaf key 81, the user is able to open the cover/inter-leaf setting screen 90 as shown in FIG. 18B.

Here, it is possible to perform various settings for inter-leaves. For example, the screen of FIG. 18B is provided with an inter-leaf A setting key 93 and an inter-leaf B setting key 94, and a setting of inter-leaf A (first inter-leaf) and a setting of inter-leaf B (second inter-leaf) are possible individually. For example, when the inter-leaf A setting key is operated in FIG. 18B, an inter-leaf A setting screen 110 as shown in FIG. 18C is opened. A copy setting key 111 for setting whether or not to perform a copy on an inter-leaf itself, a 1-sided/2-sided setting key 112 for setting whether to perform a copy on an inter-leaf in a 1-sided or 2-sided manner, and a tray selection key 113 for selecting a tray for feeding inter-leaves are provided so that settings related to inter-leaves can be performed appropriately.

It is also possible to perform settings in the same manner when inter-leaf B is selected in FIG. 18B.

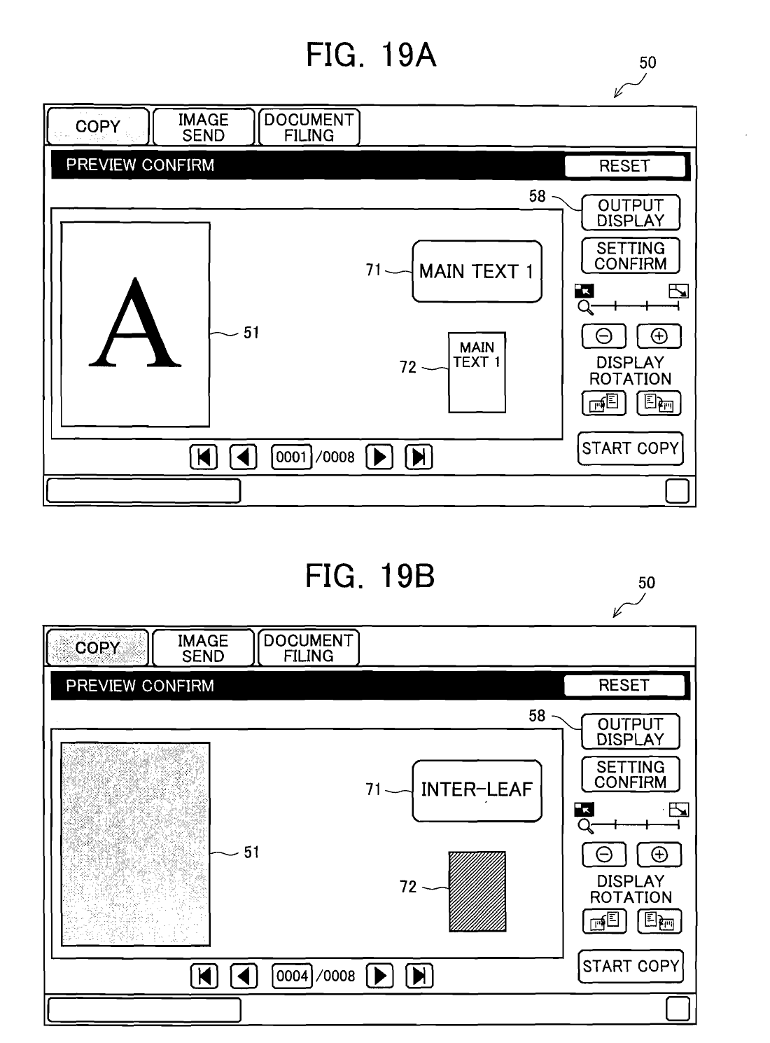

FIGS. 19A to 19C are diagrams for showing an exemplary display of information related to insertion of inter-leaves as another example of a finish state. Similarly to the above-described example, by setting print conditions and operating the preview confirm key 41 on the standard screen 40, the user is able to display a preview of image data. By operating the output display key 58 on the preview screen 50, the finish state information 71 and the icon 72 showing a finish state as shown in FIGS. 19A to 19C are able to be displayed for previewing.

In this case, the finish state information 71 concerning inter-leaf insertion and the icon 72 are displayed together with the preview image 51 on the preview screen 50. The preview image 51 is a reduced image of image data to be printed as described above and is displayed for each page. The finish state information 71 is displayed together with the preview image 51 for each page.

FIG. 19A shows a preview display screen of the first page. Here, image data of the main text serving as the first page in an inter-leaf setting is shown as the preview image 51 (indicated by “A” in the figure). “Main text 1” is displayed as the finish state information 71.

Moreover, the icon 72 showing a finish state is displayed together with the finish state information 71 on the preview screen 50 of FIG. 19A. The icon 72 showing the first page of the main text is displayed in this case. This display allows the user to recognize that image data of the current preview image 51 is the first page of the main text.

FIG. 19B shows a screen that displays a page of an inter-leaf part in the inter-leaf setting. Since it is set such that no printing is applied to inter-leaves, there is no image data displayed as the preview image 51 and “Inter-leaf” is displayed as the finish state information 71. In addition, the icon 72 showing being inter-leaves is displayed as the icon showing a finish state. In this case, when a plurality of sheets of inter-leaf are inserted, the icon 72 to which a page number is added may be used as the icon 72.

FIG. 19C shows a preview display screen of a sixth page. In this case, “Main text 6” is displayed as the finish state information 71. The icon 72 showing being the sixth page of the main text is displayed as the icon 72 showing a finish state. This display allows the user to recognize that the current preview image 51 is the sixth page of the main text.

Note that, although the icon 72 showing a finish state is displayed in addition to the finish state information 71 on the above-described preview screen, only the finish state information 71 may be displayed together with the preview image 51.

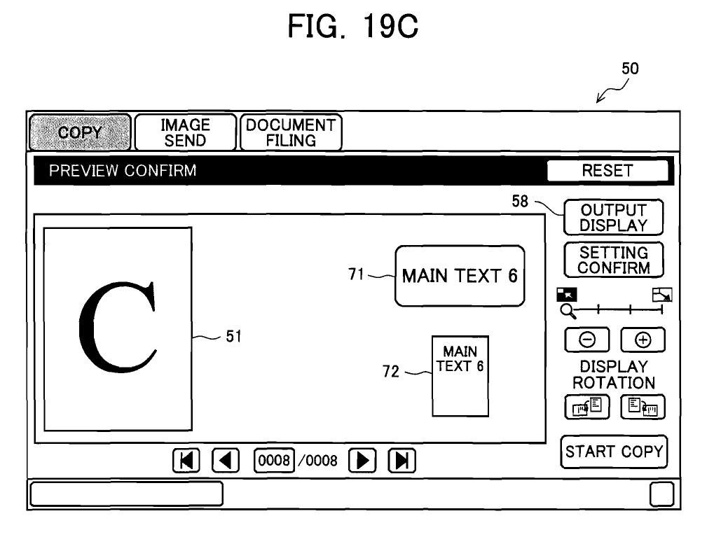

FIGS. 20A and 20B are diagrams for showing another exemplary display of information related to inter-leaves as another example of a finish state. Similarly to the above-described example, by setting print conditions and operating the preview confirm key 41 on the standard screen 40, the user is able to display a preview of image data. By operating the output display key 58 on the preview screen 50, the icon 72 showing a finish state as shown in FIGS. 20A and 20B can be displayed for previewing.

In this case, the icon 72 showing a finish state concerning an inter-leaf setting is displayed together with the preview image 51 on the preview screen 50.

FIG. 20A shows a preview display screen of a first page of the main text. In this case, image data of the main text serving as the first page (“A”) is shown as the preview image 51. The icon 72a showing an arranging state of pages after printing in a model manner and the icon 72b showing that the first page of the main text is currently shown among them are displayed as the icon 72 showing a finish state. This display allows the user to recognize that a setting for inserting two inter-leaves is performed and image data of the current preview image 51 is the first page of the main text.

FIG. 20B shows a screen that displays a preview of the first inter-leaf in the inter-leaf setting. In this case, there is no image data corresponding to the inter-leaf. The icon 72a showing an arranging state of pages after printing in a model manner and the icon 72b showing that the first inter-leaf is currently shown among them are displayed as the icon 72 showing a finish state. This display allows the user to recognize that a setting for inserting two inter-leaves is performed and image data of the current preview image 51 is the first inter-leaf.

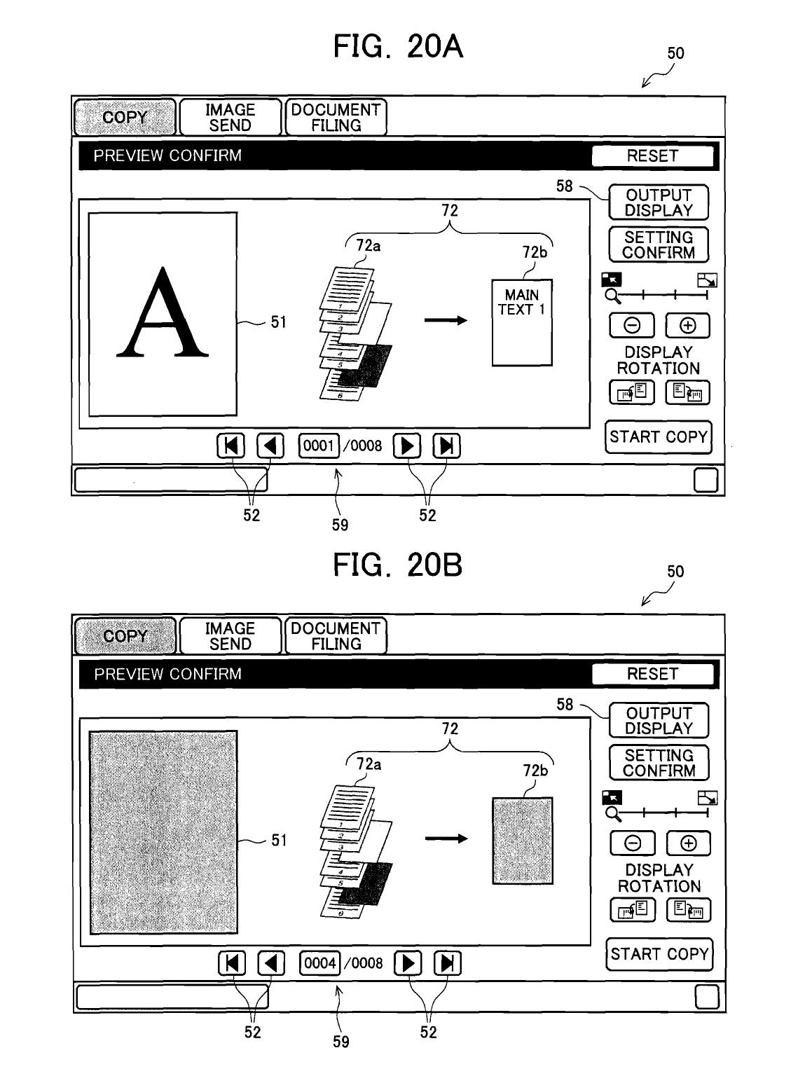

FIGS. 21A and 21B are diagrams for showing still another exemplary display of information related to an inter-leaf as another example of a finish state, and FIG. 21A shows a preview display screen of the first page of the main text. In the figure, image data of the main text serving as the first page (“A”) is shown as the preview image 51. The icon 72a showing an arranging state of pages after printing in a model manner and the icon 72b showing that a first page of the main text is currently shown among them are displayed as the icon 72 showing a finish state.

In addition thereto, the finish state information 71 represented as “Main text 1” is displayed. This display allows the user to recognize that a setting for inserting two inter-leaves is performed and image data of the current preview image 51 is the first page of the main text. In addition, an arrow 72c is displayed to indicate a current display position with respect to the icon 72a in this example. This makes it possible for the user to know where the current preview display position is in the whole approximately. For example, it is possible to know that the current display position is before the first inter-leaf in this example.

FIG. 21B shows a screen that displays a preview of the first inter-leaf in the inter-leaf setting. In this case, there is no image data corresponding to an inter-leaf. The icon 72a showing an arranging state of pages after printing in a model manner and the icon 72b showing being the first inter-leaf are displayed as the icon 72 showing a finish state. The arrow 72c indicates the first inter-leaf. In addition thereto, the finish state information 71 represented as “Inter-leaf” is displayed. This display allows the user to recognize that a setting for inserting two sheets of inter-leaf is performed and image data of the current preview image 51 is the first inter-leaf.

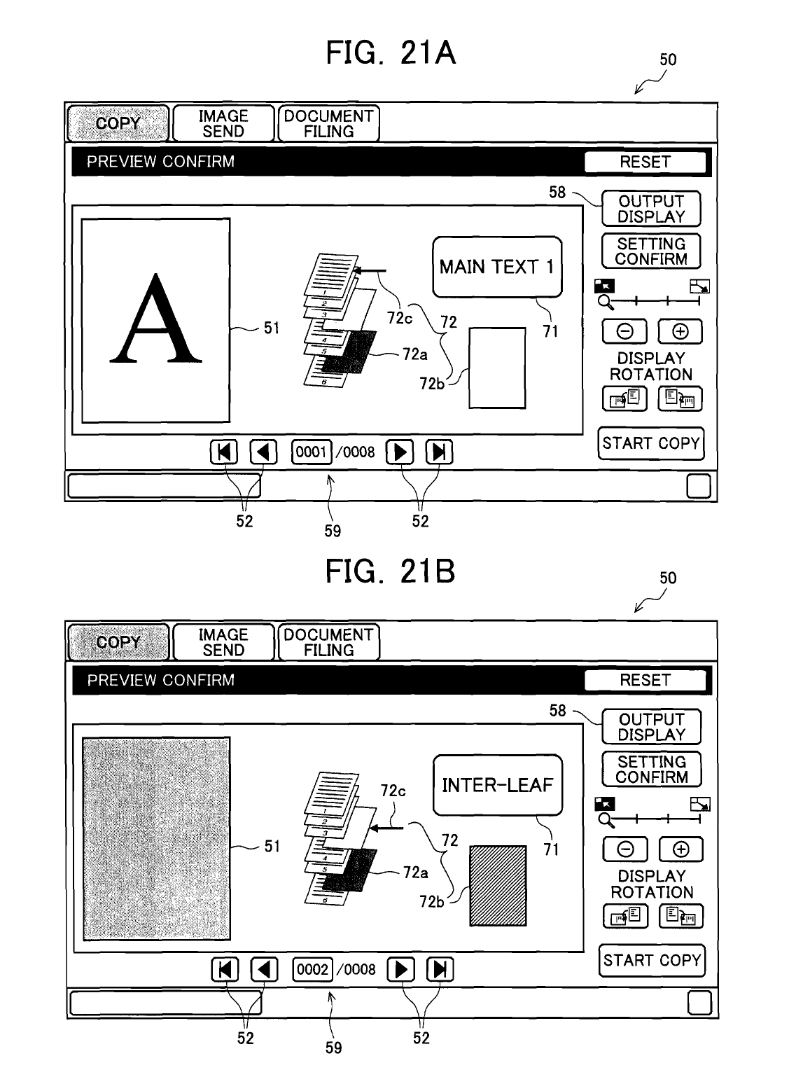

FIG. 22 is a diagram for explaining an OHP inter-leaf setting in the digital multi-functional peripheral. The OHP inter-leaf setting is to set processing of inserting different kinds of sheets of paper (inter-leaf) between sheets for OHP (Overhead Projector) in printing (performing image formation of) image data. In this case, OHP paper by a transparent film and an inter-leaf make a set and each of them is output piling on top of another. The inter-leaf is used as protection paper for the OHP paper, and, for example, plain paper is used therefor. It is possible to perform printing on the inter-leaf and it is also possible just to insert the inter-leaf without performing printing. The illustrated example shows a case where three-page original (A, B, C) are printed on the OHP paper and inter-leaves are placed after each of the OHP paper.

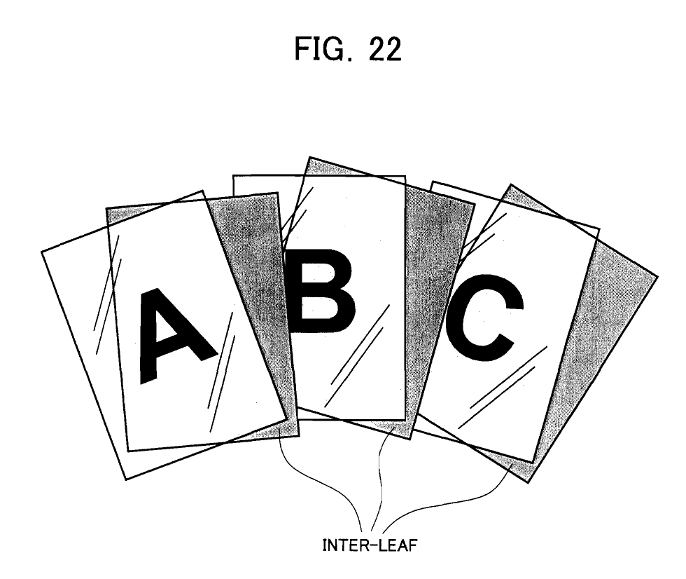

FIGS. 23A and 23B are diagrams for showing a display screen for an OHP inter-leaf setting in the digital multi-functional peripheral.

When the special modes key 43 is operated on the standard screen 40 of the digital multi-functional peripheral as shown in FIG. 4, the predetermined special modes setting screen 80 as shown in FIG. 23A can be opened. By pressing an OHP inter-leaf key 82, the user is able to open an OHP inter-leaf setting screen 120 as shown in FIG. 23B.

Here, it is possible to perform various settings for OHP inter-leaves. For example, the screen of FIG. 23B is provided with a copy setting key 121 for setting whether or not to perform a copy on an inter-leaf itself and a tray selection key 122 for selecting a tray for feeding inter-leaves so that settings related to OHP inter-leaves can be performed appropriately.

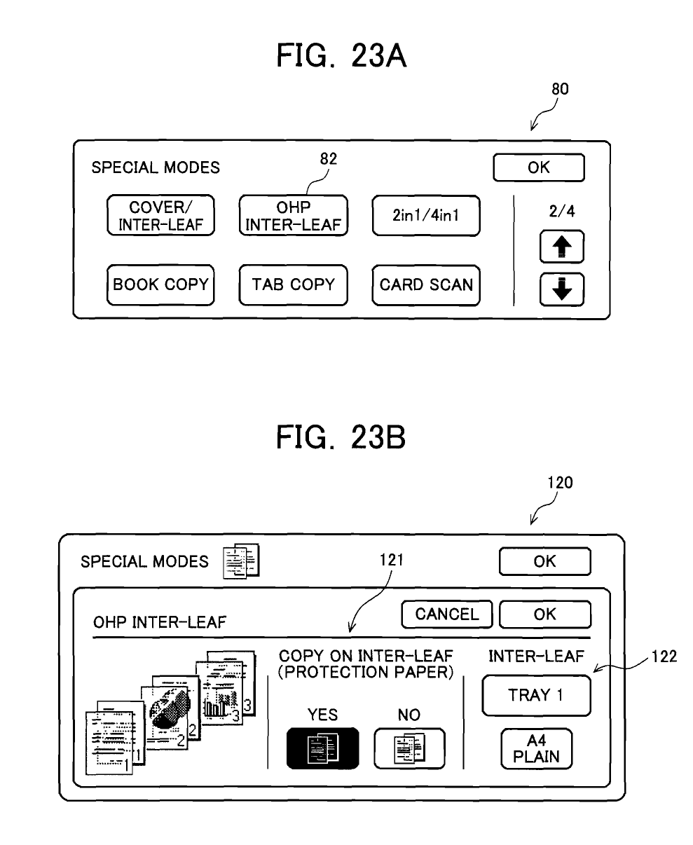

FIGS. 24A and 24B are diagrams for showing an exemplary display of information related to OHP inter-leaves as still another example of a finish state. Similarly to the above-described example, by setting print conditions and operating the preview confirm key 41 on the standard screen 40, the user is able to display a preview of image data. By operating the output display key 58 on the preview screen 50, the finish state information 71 as shown in FIGS. 24A and 24B and the icon 72 showing a finish state can be displayed for previewing.

The preview image 51 is a reduced image of image data to be printed as described above and is displayed for each page. The finish state information 71 and the icon 72 are displayed together with the preview image 51 for each page.

FIG. 24A shows a preview display screen of the first page. Here, image data serving as the first page in an OHP inter-leaf setting (indicated by “A” in the figure) is shown as the preview image 51. OHP is displayed as the finish state information 71. This display allows the user to recognize that image data of the current preview image 51 is the first page of the image data to be printed on OHP paper.

Moreover, the icon 72 showing a finish state is displayed together with the finish state information 71 on the preview screen 50 of FIG. 24A. The icon 72 is previously prepared in accordance with a printing setting and held by the digital multi-functional peripheral, and the icon 72 showing being OHP is displayed in the figure.

FIG. 24B shows a screen that displays the second page in the OHP inter-leaf setting. Since it is set such that printing is performed on inter-leaves in this case, “A” which is the same as in the first page is displayed on the preview image 51. The icon 72 showing to be an inter-leaf is displayed as 72 showing a finish state. This display allows the user to recognize that an OHP paper setting is performed and image data of the current preview image 51 is the first page of original of image data to be printed on the first OHP paper (protection paper).

The finish state information 71 including page information may be displayed in this example, and may be displayed as, for example, “OHP 1” or “Main text 1”. Similarly, the icon 72 may also include page information.

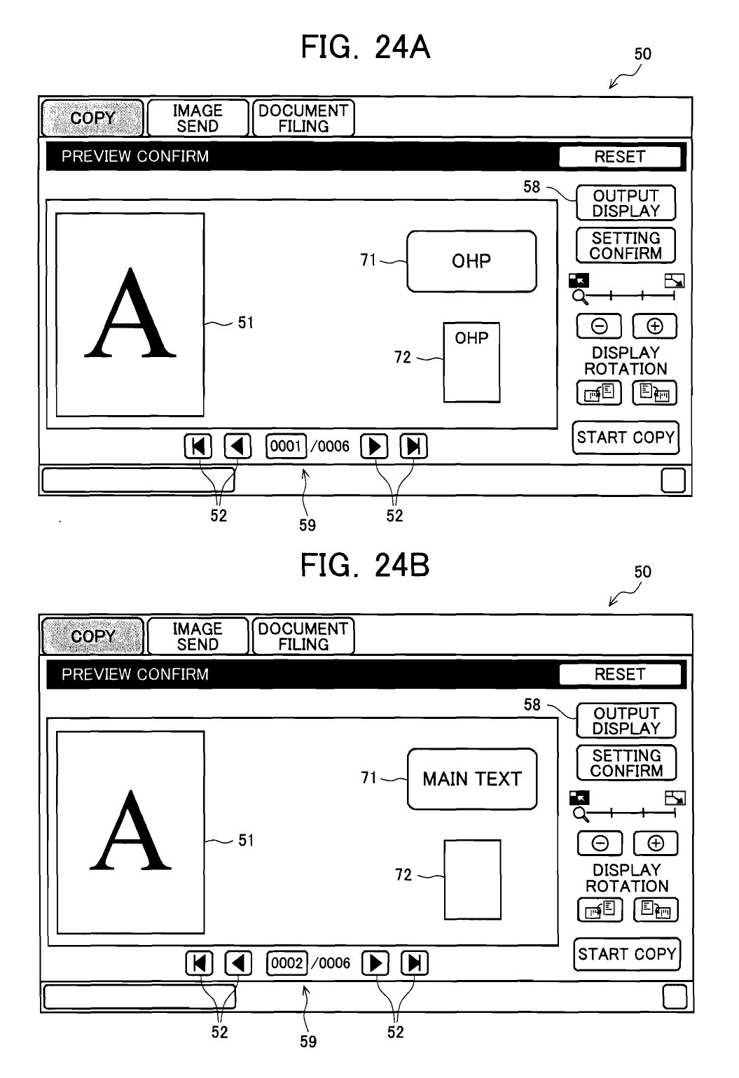

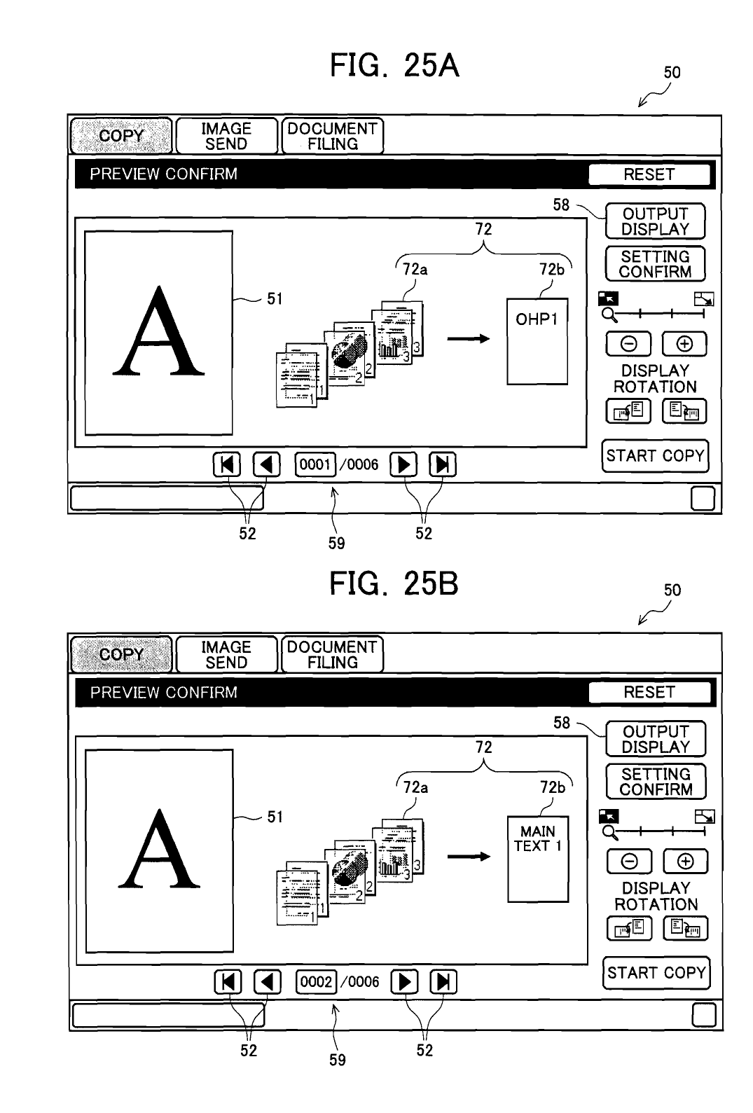

FIGS. 25A and 25B, and FIGS. 26A and 26B are diagrams for showing another exemplary display of information related to OHP inter-leaves as still another example of a finish state. Similarly to the above-described example, by setting print conditions and operating the preview confirm key 41 on the standard screen 40, the user is able to display a preview of image data. By operating the output display key 58 on the preview screen 50, the icon 72 showing a finish state as shown in FIGS. 25A and 25B can be displayed for previewing. In the figure, the icon 72 showing a finish state concerning an OHP inter-leaf setting is displayed together with the preview image 51 for each page on the preview screen 50.

FIG. 25A shows a preview display screen of the first page. In the figure, image data serving as the first page (“A”) is shown as the preview image 51. The icon 72a showing an arranging state of pages after printing in a model manner and the icon 72b showing image data for the first page of OHP paper among them are displayed as the icon 72 showing a finish state. This display allows the user to recognize that an OHP inter-leaf setting is performed and image data of the current preview image 51 is the image data of the first page of original to be printed on OHP paper.

FIG. 25B shows a preview display screen of the second page. Since it is set such that printing is also performed on inter-leaves (protection paper) in this case, “A” which is the same as in the first page is displayed on the preview image 51. The icon 72a showing an arranging state of pages after printing in a model manner and the icon 72b showing that the first page of the main text is currently displayed among them are displayed as the icon 72 showing a finish state. This display allows the user to recognize that an OHP inter-leaf setting is performed and image data of the current preview image 51 is the image data of the first page of original to be printed on the first OHP paper (protection paper).

FIG. 26A shows a preview display screen of the third page. In the figure, image data serving as the third page (“B”) is shown as the preview image 51. The image data serves as image data of the second page of original. The icon 72a showing an arranging state of pages after printing in a model manner and the icon 72b showing image data for the second page of OHP inter-leaves among them are displayed as the icon 72 showing a finish state. This display allows the user to recognize that an OHP inter-leaf setting is performed and image data of the current preview image 51 is the image data of the second page of original to be printed on OHP paper.

FIG. 26B shows a preview display screen of the fourth page. Since it is set such that printing is also performed on inter-leaves (protection paper) in this case, “B” which is the same as in the third page is displayed on the preview image 51. The icon 72a showing an arranging state of pages after printing in a model manner and the icon 72b showing being the second page of the main text among them are displayed as the icon 72 showing a finish state. This display allows the user to recognize that an OHP inter-leaf setting is performed and image data of the current preview image 51 is the image data of the second page of original to be printed on an inter-leaf (protection paper).

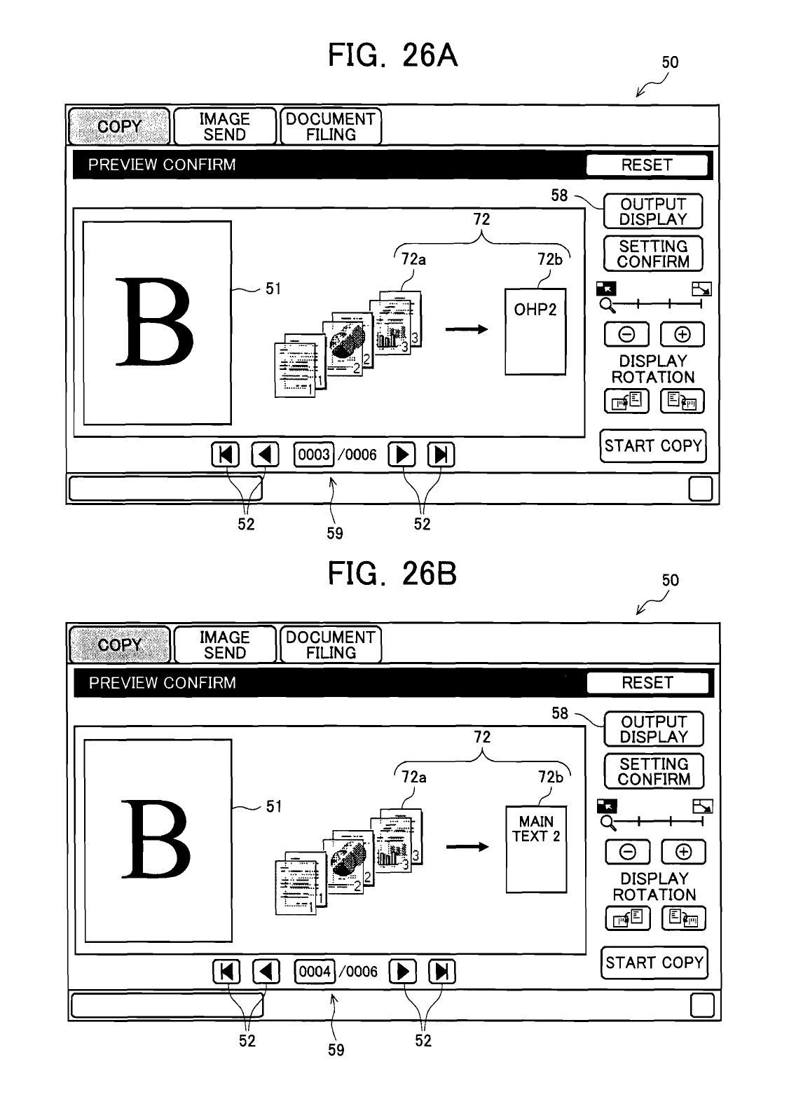

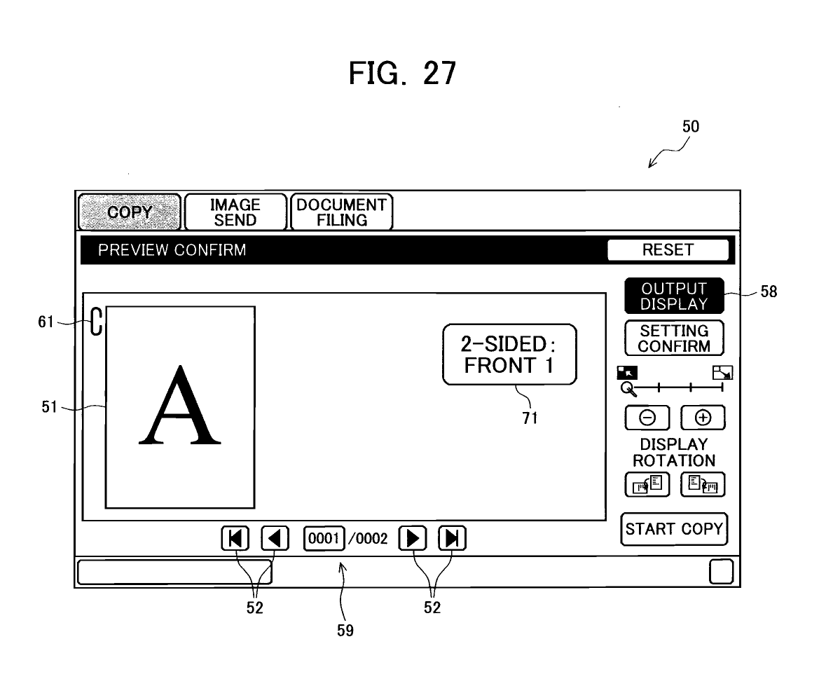

Although 2-sided printing processing, front cover/back cover insertion processing, inter-leaf insertion processing, OHP inter-leaf processing, and the like are set as the predetermined finish state that is displayed on the preview screen in the above-described example, the finish state displayed for previewing is not limited thereto and may be set appropriately. For example, a printing menu function for adding date, stamp, page, or text information to image data, a function of printing a transmission source by facsimile sending or internet FAX, a function of stacking a plurality of printed sheets to bind a sheet end part, a binding in middle position function for stacking a plurality of printed sheets and binding the same so as to be folded at the center, a book copy function for copying a book original, a function of making punch holes on printed sheets, and the like may be applied appropriately. FIG. 27 shows an exemplary display in setting a staple function and FIG. 28 shows an exemplary display in setting a punch function.

For example, in the example of FIG. 27, staple information showing a state of a printed sheet that is stapled is displayed together with the preview image 51 on the preview screen 50 which is the same as in FIGS. 8A and 8B. This makes it possible for the user to recognize that the staple is applied and a position of the staple as a finish state.

Moreover, in the example of FIG. 28, punch information showing a state of a printed sheet that is punched is displayed together with the preview image 51 on the preview screen 50 which is the same as in FIGS. 8A and 8B. This makes it possible for the user to recognize that punch holes are made and positions of the punch holes as a finish state.

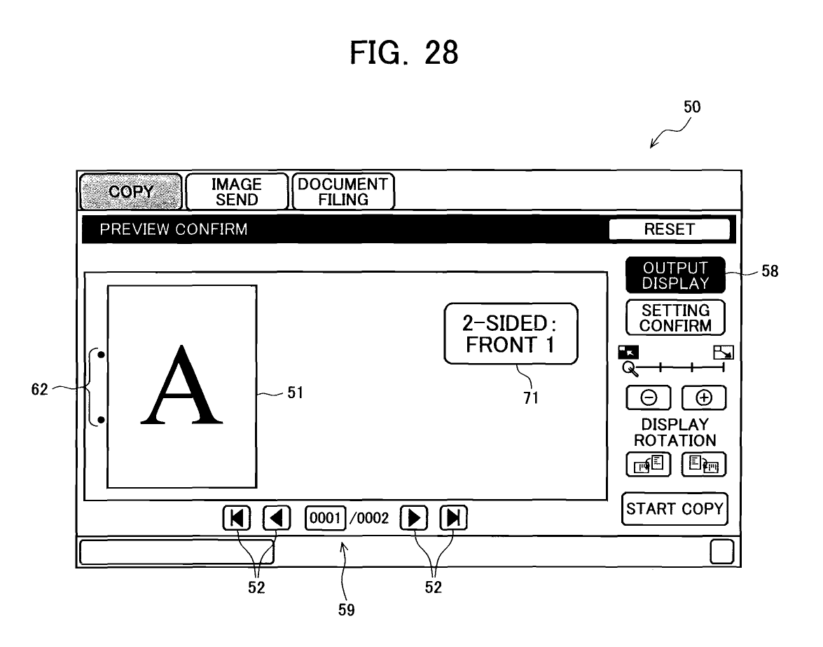

FIG. 29 is a diagram for showing an exemplary display for displaying a plurality of finish states at the same time. When a plurality of items of outputs are set to printing of image data, all of them can be displayed by the method as described above. For example, in the example of FIG. 29, three pieces of finish state information and four icons 72 are displayed on the preview screen 50.

In the figure, “Full Color” which is current color mode information 73 is displayed, and “2-sided: Front 1” showing that the preview image 51 is a front side in 2-sided printing, “OHP” showing being an OHP image by OHP inter-leaf processing, and “Cover” showing to be a cover by cover insertion processing are displayed as the finish state information 71 at the same time.

As the icon 72, an icon showing to be a front side in 2-sided printing in response to “2-sided: Front 1”, an icon showing to be an OHP image by OHP inter-leaf processing in response to “OHP”, and an icon showing to be a cover by cover insertion processing in response to “Cover” are displayed, and an icon showing a setting of printing menu is further displayed. Although the finish state information 71 is not displayed for the icon showing a setting of printing menu, predetermined finish state information may be also displayed for the printing menu.

As to a combination of the finish state information 71 and the icon 72 in one output item, it is possible to set such that either one of or both pieces of information is displayed appropriately.

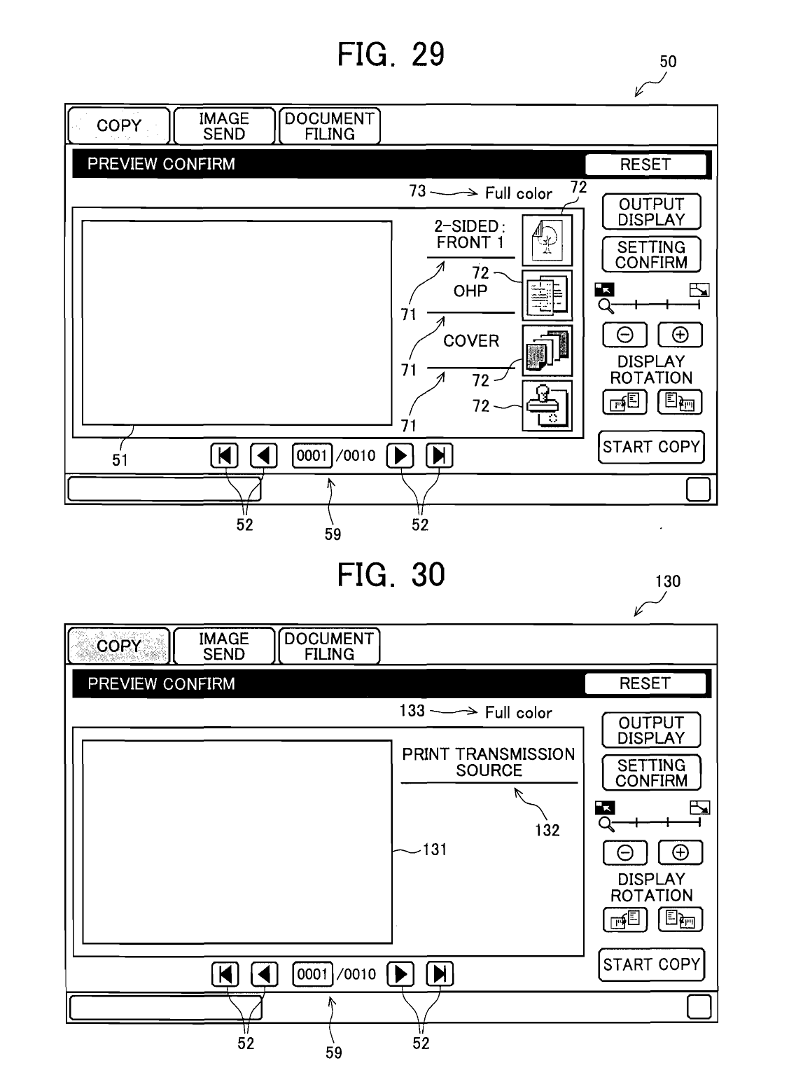

FIG. 30 is a diagram for showing an exemplary display of finish state information in a preview display in sending image data.

Although the embodiment related to the preview display of image data in performing image formation has been shown in each example described above, the digital multi-functional peripheral of this example is capable of sending image data of an original read by the reading portion as described above to an external device via facsimile or internet. In this case, it is possible to preview the image data to be sent.

A preview image 131 of the image data to be sent is displayed on a preview screen 130 for the sent image. The screen displays finish state information 132 showing to print information indicating a transmission source as one piece of finish state information. This makes it possible for the user to recognize that it is set such that information of a sending source is added to image data to be sent via facsimile or internet and printing is performed with the sending source information added at a sending destination. Also in this example, a predetermined icon may be displayed together with the finish state information 132 or instead of the finish state information 132. “Full Color” which is current color mode information 133 is also displayed in this case.

In this manner, information showing a finish state that is displayed together with a preview image is applicable not only to a preview screen in performing image formation by the image forming portion but also to a preview screen in sending image data by facsimile or internet.

According to the present invention, the following effects are obtained.

According to the present invention, it is possible to provide an image forming apparatus that enables to prevent unnecessary image formation processing due to setting errors by a user by making it possible to confirm a finish state on a preview screen reliably.

1. An image forming apparatus that includes a display portion; an operation input portion for performing operation input in accordance with a display of the display portion; an image forming portion for performing image formation of image data; and a display control portion for displaying a preview image of the image data on the display portion before performing the image formation, wherein
in a state where the preview image of the image data is displayed, operation input for displaying a finish state of image formation is possible by the operation input portion and
when operation input for displaying the finish state is performed for the operation input portion, the display control portion causes the display portion to display information showing the finish state separately from the preview image of the image data according to finish conditions set to the image forming apparatus.

2. The image forming apparatus as defined in claim 1, wherein
while information showing the finish state is displayed on the display portion, when operation input for displaying the finish state is performed by the operation input portion again, the display control portion deletes a display showing the finish state that is displayed on the display portion.

3. The image forming apparatus as defined in claim 1, wherein
while information showing the finish state is displayed on the display portion, when operation input for displaying the finish state is performed by the operation input portion again, the display control portion returns to a display in which the preview image of the image data is displayed and information showing the finish state is not displayed.

4. The image forming apparatus as defined in claim 1, wherein
when causing the display portion to display information showing the finish state, the display control portion displays a reduced image showing an entire page of a page of image data for performing image formation as the preview image,
and displays page information of a page corresponding to the reduced image and the reduced image at the same time as information showing the finish state.

5. The image forming apparatus as defined in claim 4, wherein
the page information includes information related to 2-sided printing processing for performing image formation on both sides of paper.

6. The image forming apparatus as defined in claim 4, wherein
the page information includes information related to the inter-leaf processing for inserting paper as an inter-leaf in a predetermined position of paper for performing image formation.

7. The image forming apparatus as defined in claim 4, wherein
the page information includes information related to OHP inter-leaf processing for inserting sheets of paper as inter-leaves between sheets of OHP paper.

8. The image forming apparatus as defined in claim 4, wherein
the page information includes information related to front cover insertion processing for inserting a sheet of paper as a front cover in a top page position for performing image formation.

9. The image forming apparatus as defined in claim 4, wherein
the page information includes information related to back cover insertion processing for inserting a sheet of paper as a back cover in the last page position for performing image formation.

10. The image forming apparatus as defined in claim 4, wherein
the page information includes information displayed by an icon.

11. The image forming apparatus as defined in any one of claims 1 to 10, wherein
a sending portion for sending image data to an external device is included, and
before image data is sent by the sending portion, the display control portion causes the display portion to display a preview image of the image data and information showing a finish state separately from the preview image in accordance with finish conditions set in the image forming apparatus.
